(19) United States
(12) Patent Application Publication
(10) Pub. No.: US 2026/0100523 A1
(43) Pub. Date: Apr. 9, 2026

(54) ELECTRICAL CONNECTION UNIT

(71) Applicant: YAZAKI CORPORATION, Tokyo (JP)

(72) Inventors: Ryu Senoo, Kakegawa-shi (JP); Hirotaka Mukasa, Kakegawa-shi (JP); Kazuhiko Tsuchiya, Kakegawa-shi (JP)

(21) Appl. No.: 19/347,776

(22) Filed: Oct. 2, 2025

(30) Foreign Application Priority Data
Oct. 7, 2024 (JP) 2024-176015

(51) Int. Cl. H01R 4/30; H02G 3/16

(52) U.S. Cl. CPC H01R 4/305; H02G 3/16

(57) ABSTRACT

An electrical connection unit includes a support, a first bus bar, a second bus bar, a first electronic component, and a second electronic component. The support has a first surface and a second surface located on a side opposite to the first surface. The first bus bar is supported by the support. The second bus bar is supported by the support. The first electronic component faces the first surface of the support, and is electrically connected to the first bus bar. The second electronic component faces the second surface of the support, and is electrically connected to the second bus bar.

### TECHNICAL FIELD

Embodiments of the present invention relate to an electrical connection unit.

Priority is claimed on Japanese Patent Application No. 2024-176015 filed in Japan on Oct. 7, 2024, the content of which is incorporated herein by reference.

### BACKGROUND ART

An electrical connection unit having an electronic component and a bus bar connected to the electronic component is known.

### PRIOR ART DOCUMENT

### Patent Document

[Patent Document 1] Japanese Unexamined Patent Application, First Publication No. 2024-037492

### SUMMARY OF THE INVENTION

### Problems to be Solved by the Invention

Incidentally, an electrical connection unit is expected to be miniaturized.

An embodiment provides an electrical connection unit that can be miniaturized.

### Means for Solving the Problem

An electrical connection unit according to an embodiment includes a support, a first bus bar, a second bus bar, a first electronic component, and a second electronic component. The support has a first surface and a second surface located on a side opposite to the first surface. The first bus bar is supported by the support. The second bus bar is supported by the support. The first electronic component faces the first surface of the support, and is electrically connected to the first bus bar. The second electronic component faces the second surface of the support, and is electrically connected to the second bus bar.

### Effects of Invention

According to one embodiment, the electrical connection unit can be miniaturized.

### BRIEF DESCRIPTION OF THE DRAWINGS

FIG. 1 A cross-sectional view illustrating an electrical connection unit of a first embodiment.

FIG. 2 A perspective view for describing a main body of the first embodiment.

FIG. 3 A perspective view for describing a subunit of the first embodiment.

FIG. 4 A partially exploded perspective view of the subunit of the first embodiment.

FIG. 5 A perspective view for describing an electronic component and a connection component of the first embodiment.

FIG. 6 A perspective view for describing the electronic component and the connection component of the first embodiment.

FIG. 7 A perspective view illustrating the connection component of the first embodiment.

FIG. 8 A perspective view illustrating a routing board of the first embodiment.

FIG. 9 A partially exploded perspective view of the routing board of the first embodiment.

FIG. 10 A plan view illustrating the routing board of the first embodiment.

FIG. 11 A partially exploded perspective view of the electrical connection unit of the first embodiment.

FIG. 12 A bottom view illustrating the routing board of the first embodiment.

FIG. 13 A cross-sectional view taken along line F13-F13 of a structure illustrated in FIG. 10.

FIG. 14 A plan view illustrating a part of an electrical connection unit of a first modification example of the first embodiment.

FIG. 15 A cross-sectional view taken along line F15-F15 of the structure illustrated in FIG. 14.

FIG. 16 A plan view illustrating a part of an electrical connection unit of a second modification example of the first embodiment.

FIG. 17 A cross-sectional view illustrating an electrical connection unit of a third modification example of the first embodiment.

FIG. 18 A cross-sectional view illustrating an electrical connection unit of a fourth modification example of the first embodiment.

FIG. 19 A perspective view illustrating a part of an electrical connection unit of a fifth modification example of the first embodiment.

FIG. 20 A cross-sectional view taken along line F20-F20 of the structure illustrated in FIG. 19.

FIG. 21 A cross-sectional view illustrating an electrical connection unit of a second embodiment.

FIG. 22 A perspective view illustrating a part of the electrical connection unit of the second embodiment.

FIG. 23 A cross-sectional view taken along line F23-F23 of the structure illustrated in FIG. 22.

FIG. 24 A cross-sectional view taken along line F24-F24 of the structure illustrated in FIG. 22.

FIG. 25 A cross-sectional view illustrating an electrical connection unit of a third embodiment.

FIG. 26 An exploded perspective view illustrating a part of the electrical connection unit of the third embodiment.

FIG. 27 A cross-sectional view illustrating a part of the electrical connection unit of the third embodiment.

### EMBODIMENTS FOR CARRYING OUT THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “accommodation” is not limited to a case where the entire component is accommodated, and may include a case where only a part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. The term “adjacent” is not limited to a case where two elements are in contact with each other, and may include a case where two elements are disposed to be arranged in a state of being separated from each other. “Parallel”, “orthogonal”, or “the same” may include “substantially parallel”, “substantially orthogonal”, or “substantially the same”, respectively.

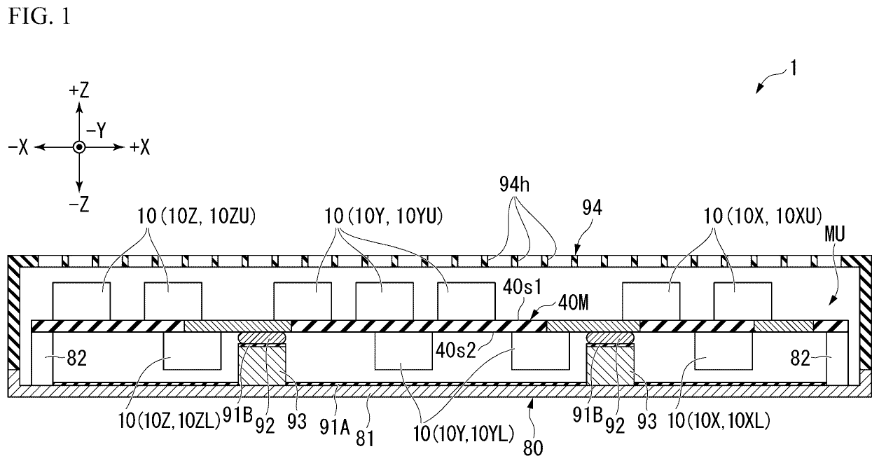

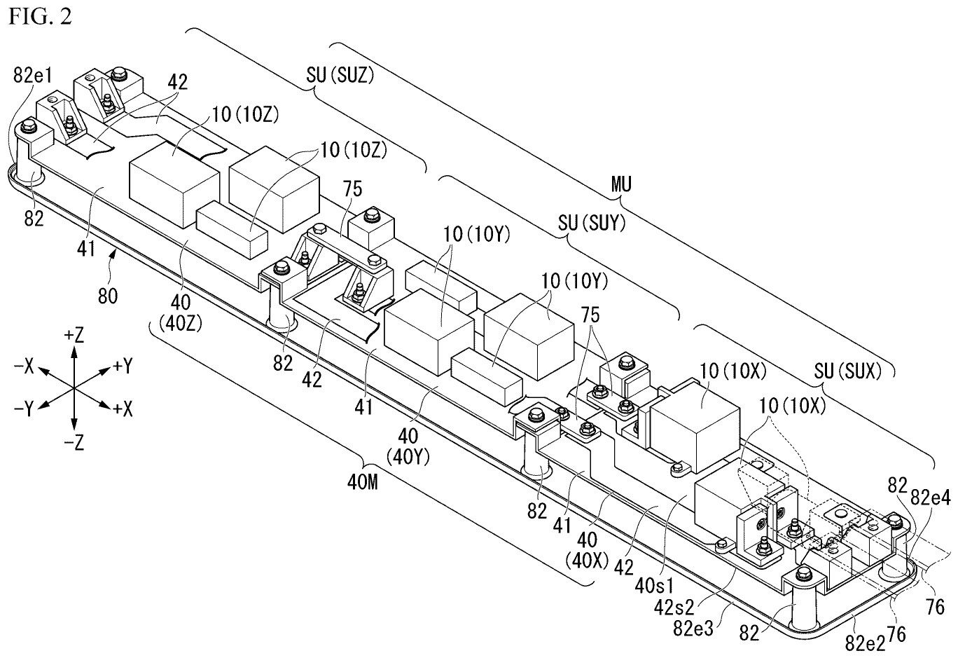

In the present disclosure, a +X direction, a −X direction, a +Y direction, a −Y direction, a +Z direction, and a −Z direction are defined as follows. The +X direction is a direction from a first end 80e1 to a second end 80e2 of a metal plate 80 that will be described later (see FIG. 2). The −X direction is a direction opposite to the +X direction. Hereinafter, in a case where the +X direction and the −X direction are not distinguished, the directions will be simply referred to as “X direction”. The +Y direction and the −Y direction are directions intersecting (for example, orthogonal to) the X direction. The +Y direction is a direction from a third end 80e3 to a fourth end 80e4 of the metal plate 80 that will be described later (see FIG. 2). The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting (for example, orthogonal to) the X direction and the Y direction. The +Z direction is a direction from a second surface 40s2 of a routing board 40M that will be described later toward a first surface 40s1 (see FIG. 1). The −Z direction is a direction opposite to the +Z direction. Hereinafter, in a case where the +Z direction and the −Z direction are not distinguished, the directions will be simply referred to as “Z direction”. The Z direction is an example of a “first direction”. One of the X direction and the Y direction is an example of a “second direction”.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture of the electrical connection unit 1).

### FIRST EMBODIMENT

### 1. Constitution of Electrical Connection Unit

FIG. 1 is a cross-sectional view illustrating an electrical connection unit 1 of an embodiment. The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box”, for example. However, the electrical connection unit 1 is not limited to a box-shaped device.

The electrical connection unit 1 includes, for example, a main body MU, a metal plate 80, insulating sheets 91A and 91B, a plurality of heat transfer members 92, a plurality of heat transfer portions 93, and an insulating cover 94.

### 2. Main Body

First, the main body MU will be described.

FIG. 2 is a perspective view for describing the main body MU. The main body MU is a portion that performs a main function (for example, switching of electrical connection states or overcurrent protection) of the electrical connection unit 1. In the present embodiment, the main body MU is divided into a plurality of subunits SU. The main body MU is formed by connecting a plurality of subunits SU. In the present embodiment, the main body MU includes three subunits SU (subunits SUX, SUY, and SUZ). Each subunit SU may be referred to as a “circuit constitution body”.

The subunit SUX has an electrical first function. The subunit SUX includes, for example, a plurality of electronic components 10X and a first routing board 40X. The plurality of electronic components 10X are electrically connected to the first routing board 40X. The plurality of electronic components 10X include, for example, one or more electronic components 10XU and one or more electronic components 10XL (see FIG. 1). The electronic component 10XU is disposed on the +Z direction side with respect to the first routing board 40X (routing board 40M). The electronic component 10XU faces a first surface 40s1 of the routing board 40M. On the other hand, the electronic component 10XL is disposed on the −Z direction side with respect to the first routing board 40X (routing board 40M). The electronic component 10XL faces a second surface 40s2 of the routing board 40M.

The subunit SUY has an electrical second function. The second function is a function different from the first function. The subunit SUY includes, for example, a plurality of electronic components 10Y and a second routing board 40Y. The plurality of electronic components 10Y are electrically connected to the second routing board 40Y. The plurality of electronic components 10Y include, for example, one or more electronic components 10YU and one or more electronic components 10YL (see FIG. 1). The electronic component 10YU is disposed on the +Z direction side with respect to the second routing board 40Y (routing board 40M). The electronic component 10YU faces the first surface 40s1 of the routing board 40M. On the other hand, the electronic component 10YL is disposed on the −Z direction side with respect to the second routing board 40Y (routing board 40M). The electronic component 10YL faces the second surface 40s2 of the routing board 40M.

The subunit SUZ has an electrical third function. The third function is a function different from the first function and the second function. The subunit SUZ includes, for example, a plurality of electronic components 10Z and a third routing board 40Z. The plurality of electronic components 10Z are electrically connected to the third routing board 40Z. The plurality of electronic components 10Z include, for example, one or more electronic components 10ZU and one or more electronic components 10ZL (see FIG. 1). The electronic component 10ZU is disposed on the +Z direction side with respect to the third routing board 40Z (routing board 40M). The electronic component 10ZU faces the first surface 40s1of the routing board 40M. On the other hand, the electronic component 10ZL is disposed on the −Z direction side with respect to the third routing board 40Z (routing board 40M). The electronic component 10ZL faces the second surface 40s2 of the routing board 40M.

In the present embodiment, the three subunits SUX, SUY, and SUZ are disposed to be arranged in the X direction. For example, the subunit SUX is disposed on the +X direction side with respect to the subunit SUY. The subunit SUX and the subunit SUY are electrically connected via a plurality of coupling bus bars 75 extending over the first routing board 40X and the second routing board 40Y. On the other hand, the subunit SUZ is disposed on the −X direction side with respect to the subunit SUY. The subunit SUZ and the subunit SUY are electrically connected via a plurality of coupling bus bars 75 (only one is illustrated in FIG. 2) extending over the third routing board 40Z and the second routing board 40Y. The coupling bus bar 75 may be disposed on the +Z direction side or the −Z direction side with respect to the plurality of subunits SU.

In the present embodiment, the three routing boards 40X, 40Y, and 40Z included in the three subunits SUX, SUY, and SUZ are disposed on the same plane. In other words, the three routing boards 40X, 40Y, and 40Z are disposed at the same height position in the Z direction. As a result, one large routing board 40M is formed by the three routing boards 40X, 40Y, and 40Z.

The routing board 40M has the first surface 40s1 and the second surface 40s2 (see FIG. 1). The first surface 40s1 is a surface directed in the +Z direction. The first surface 40s1 is formed by, for example, a first surface 51a (that will be described later) of a flat surface portion 51 of the base plate 41 of the three routing boards 40X, 40Y, and 40Z. On the other hand, the second surface 40s2 is located on the side opposite to the first surface 40s1 . The second surface 40s2 is a surface directed in the −Z direction. The second surface 40s2 is formed by, for example, a second surface 51b (that will be described later) of the flat surface portion 51 of the base plate 41 of the three routing boards 40X, 40Y, and 40Z.

In the present embodiment, the three subunits SUX, SUY, and SUZ have the same or similar basic structure. Therefore, one subunit SU will be described in detail below as a representative. Hereinafter, in a case where the subunit SUX, the subunit SUY, and the subunit SUZ are not distinguished, the subunits are simply referred to as “subunit SU”. In addition, in a case where the electronic component 10X, the electronic component 10Y, and the electronic component 10Z are not distinguished, the electronic components are simply referred to as “electronic component 10”. Similarly, in a case where the electronic component 10XU, the electronic component 10YU, and the electronic component 10ZU are not distinguished, the electronic components are simply referred to as “electronic component 10U”. In a case where the electronic component 10XL, the electronic component 10YL, and the electronic component 10ZL are not distinguished, the electronic components are simply referred to as “electronic component 10L”. In a case where the first routing board 40X, the second routing board 40Y, and the third routing board 40Z are not distinguished, the routing boards are simply referred to as “routing board 40”. One subunit SU included in the three subunits SUX, SUY, and SUZ is an example of a “first subunit”. On the other hand, another subunit SU included in the three subunits SUX, SUY, and SUZ is an example of a “second subunit”.

Note that the main body MU need not be divided into a plurality of subunits SU instead of the example described above. That is, the main body MU may be formed by the plurality of electronic components 10 and one routing board 40. In addition, the two or more subunits SU are not limited to the subunits SU having different functions, and may be the subunits SU having the same function.

### 3. Constitution of Subunit

Next, a constitution of the subunit SU will be described.

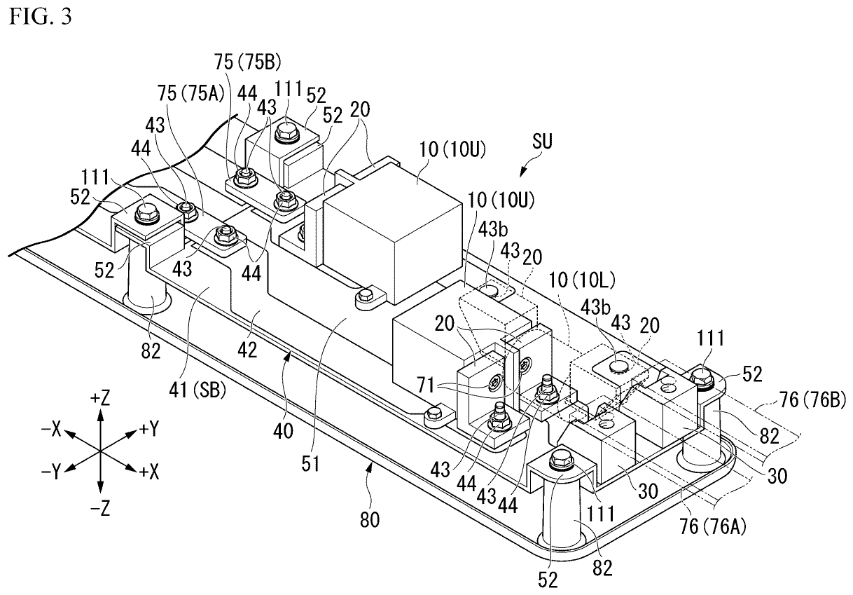

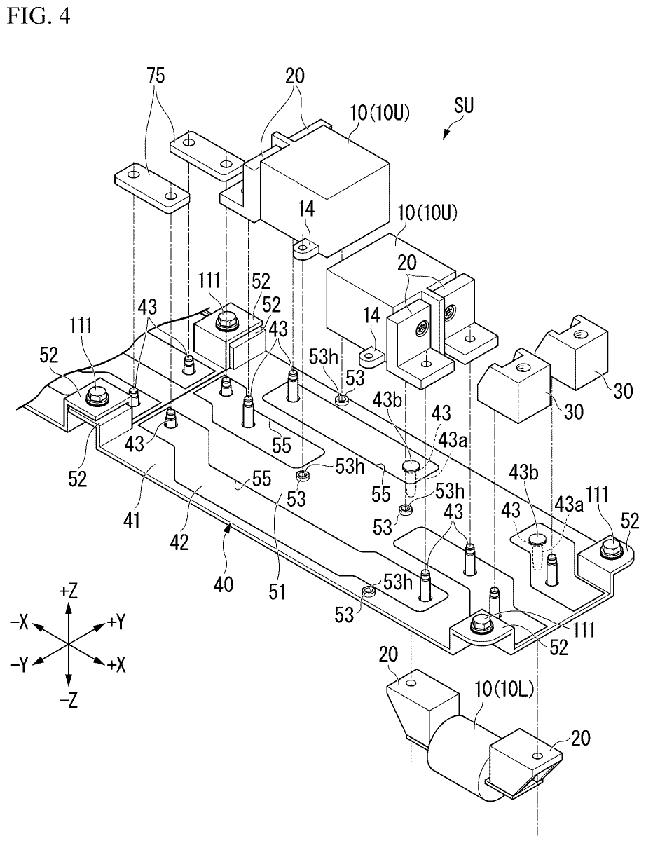

FIG. 3 is a perspective view for describing the subunit SU. FIG. 4 is a partially exploded perspective view of the subunit SU. The subunit SU includes, for example, a plurality of electronic components 10, a plurality of connection components 20 for component connection, a plurality of connection components 30 for external connection, and a routing board 40. The connection components 20 and 30 are members forming an energization path in the vertical direction. The connection components 20 and 30 may be referred to as “vertical routing members”.

### 3.1 Electronic Component and Connection Component for Component Connection

First, the electronic component 10 and the connection component 20 for component connection will be described.

The electronic component 10 is an electronic component mounted according to a function required for the subunit SU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. Note that the type of the electronic component 10 is not limited to the above example. The electronic component 10 is, for example, a heat generating component that generates heat at the time of energization. Hereinafter, a first-type electronic component 10M and a second-type electronic component 10N will be described as examples of the electronic component 10.

The connection component 20 is a component that electrically connects the electronic component 10 to the routing board 40. The connection component 20 forms a part of an energization path in the subunit SU. The connection component 20 is made of a metal (for example, copper or a copper alloy). The connection component 20 may be referred to as a “metal component”. Hereinafter, a first-type connection component 20M and a second-type connection component 20N will be described as examples of the connection component 20.

### 3.1.1 First-type Electronic Component

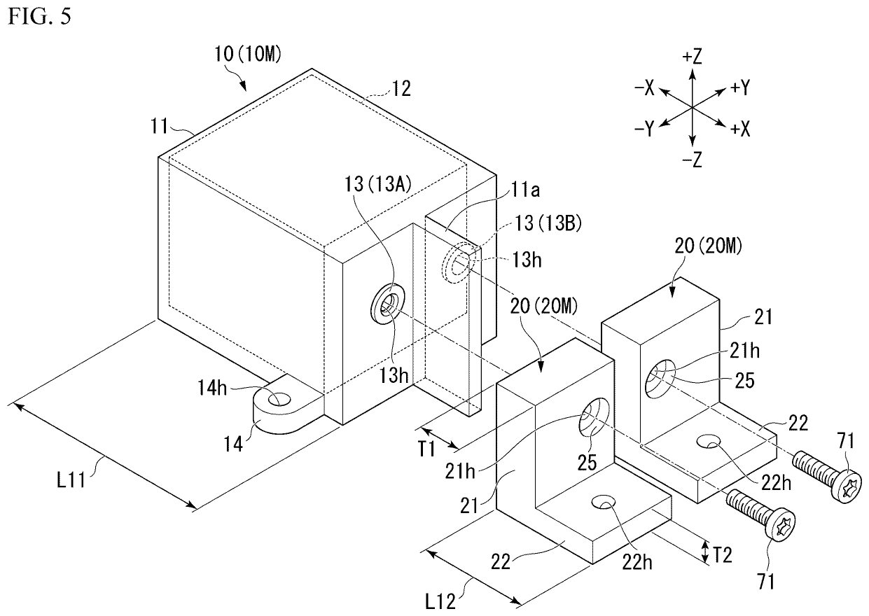

FIG. 5 is a perspective view illustrating the first-type electronic component 10M and the first-type connection component 20M. In FIG. 5, for convenience of description, the electronic component 10M and the connection component 20M are illustrated with reference to the posture of the electronic component 10 (electronic component 10U) disposed on the +Z direction side with respect to the routing board 40. The first-type electronic component 10M is an electronic component in which a plurality of terminals 13 are disposed to be arranged at one end of the electronic component 10M. The electronic component 10M includes, for example, a case 11, a component body 12, a plurality of terminals 13, and a plurality of attachment portions 14.

### (Case)

The case 11 is an outer member that forms most of the outer shape of the electronic component 10M. The case 11 is made of, for example, synthetic resin and has an insulating property. The case 11 accommodates the component body 12. The case 11 and the component body 12 may be integrally formed.

In the present embodiment, the case 11 has an insulating rib 11a that protrudes in the horizontal direction (for example, the X direction) and extends in the Z direction. The insulating rib 11a has, for example, a plate shape formed in the horizontal direction (for example, the X direction) and the Z direction. The insulating rib 11a extends over the entire length of the case 11 in the Z direction, for example. The insulating rib 11a is disposed between the plurality of terminals 13 (a terminal 13A and a terminal 13B that will be described later). The insulating rib 11a electrically insulates the terminal 13A from the terminal 13B. In the present embodiment, a part of the insulating rib 11a is disposed between first portions 21 (that will be described later) of two connection components 20M connected to the electronic component 10M. The insulating rib 11a electrically insulates the first portions 21 of the two connection components 20M connected to the electronic component 10M from each other.

### (Component Body)

The component body 12 is a portion that performs a main function of the electronic component 10M. For example, in a case where the electronic component 10M is a relay, the component body 12 includes a switch (for example, a contact) that switches between a conductive state and a non-conductive state. For example, in a case where the electronic component 10M is a fuse, the component body 12 includes a fusion portion that is fused when an overcurrent flows. For example, in a case where the electronic component 10M is a capacitor, the component body 12 includes a portion that stores electric charge.

### (Terminal)

The terminal 13 is an electrical connection portion exposed to the outside of the case 11. The terminal 13 is electrically connected to the component body 12 inside the case 11. In the present embodiment, the electronic component 10M includes a terminal 13A and a terminal 13B as the plurality of terminals 13. One of the terminal 13A and the terminal 13B is a terminal on the positive electrode side. The other of the terminal 13A and the terminal 13B is a terminal on the negative electrode side. One of the terminal 13A and the terminal 13B is an example of a “first terminal”. The other of the terminal 13A and the terminal 13B is an example of a “second terminal”.

In the present embodiment, the terminal 13A and the terminal 13B are provided at one end of the electronic component 10M in the horizontal direction (for example, the X direction). The terminal 13A and the terminal 13B are disposed to be arranged in the horizontal direction (for example, the Y direction). Each terminal 13 has an attachment hole 13h to which a fastening member 71 (for example, a screw or a bolt) that will be described later is attached. The attachment hole 13h is open in the horizontal direction (for example, the X direction). An inner circumferential surface of the attachment hole 13h of the electronic component 10M has a screw groove.

### (Attachment Portion)

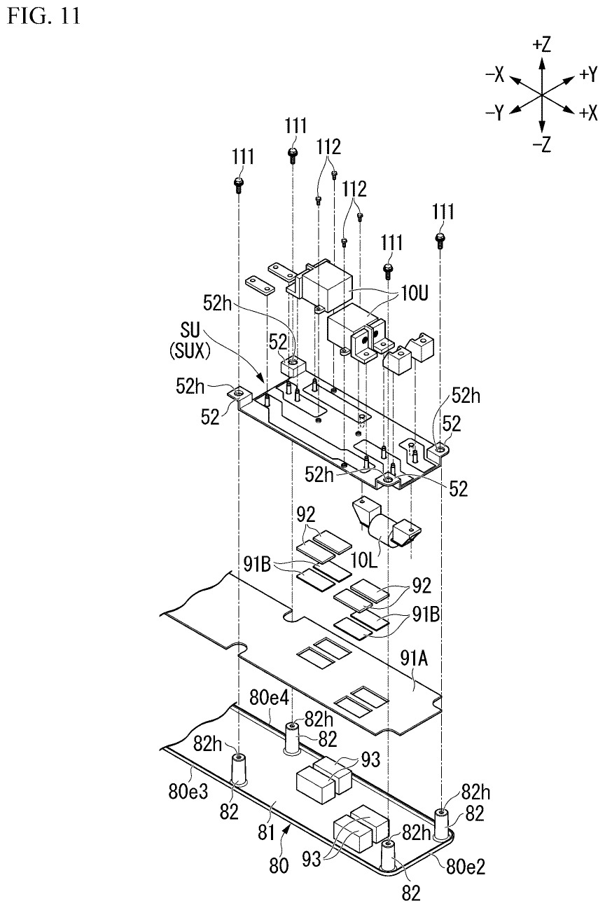

The attachment portion 14 is a portion for fixing the electronic component 10M. The attachment portion 14 has an attachment hole 14h to which a fastening member 112 (for example, a screw or a bolt; and see FIG. 11) that will be described later is attached. The attachment hole 14h is open in the Z direction. The attachment hole 14h is an insertion hole through which the fastening member 112 passes. A fixing destination of the attachment portion 14 will be described later.

### 3.1.2 First-Type Connection Component

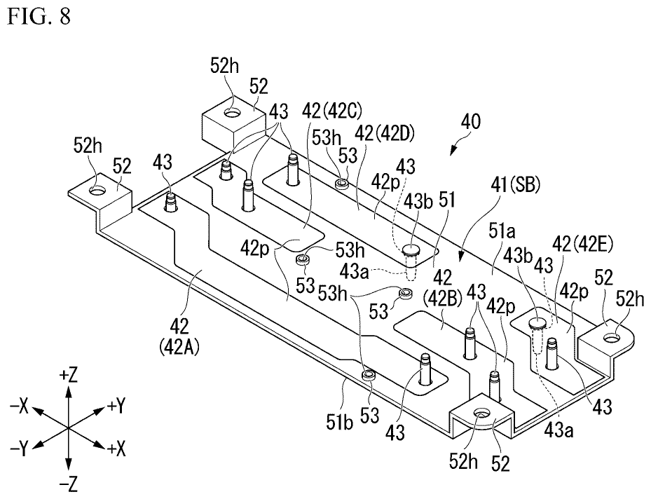

The first-type connection component 20M is a component that electrically connects the first-type electronic component 10M to the routing board 40. In the present embodiment, the connection component 20M electrically connects the electronic component 10M to a bus bar 42 (see FIG. 8) included in the routing board 40. In the present embodiment, a width L12 of the connection component 20M in a longitudinal direction (for example, the X direction) of the electronic component 10M is smaller than a width L11 of the electronic component 10M in the longitudinal direction. The connection component 20M includes, for example, a first portion 21 and a second portion 22.

### (First Portion)

The first portion 21 of the connection component 20M is a portion connected to the terminal 13 of the electronic component 10M. The first portion 21 is a plate-shaped or rectangular parallelepiped portion extending in the Z direction. The first portion 21 extends in the Z direction along one end (for example, an end in the X direction) of the electronic component 10M. The first portion 21 is a standing portion that stands in the Z direction with respect to the routing board 40 (for example, with respect to a bus bar 42 that will be described later). The first portion 21 is adjacent to the electronic component 10M in the horizontal direction (for example, the X direction). For example, the first portion 21 is adjacent to the terminal 13 of the electronic component 10M in the horizontal direction (for example, the X direction), and is connected to the terminal 13 of the electronic component 10M from the horizontal direction (for example, the X direction).

The first portion 21 of the connection component 20M has a first attachment hole 21h through which the fastening member 71 (for example, a screw or a bolt) passes. The first attachment hole 21h is open in the horizontal direction (for example, the X direction). The first portion 21 has a recess 25 around the first attachment hole 21h. The recess 25 is an accommodation portion that accommodates a head of the fastening member 71 inserted into the first attachment hole 21h. The fastening member 71 that has passed through the first attachment hole 21h is engaged with the attachment hole 13h of the terminal 13 of the electronic component 10M, and thus the first portion 21 is physically and electrically connected to the terminal 13 of the electronic component 10M. The first portion 21 need not have the recess 25.

### (Second Portion)

The second portion 22 of the connection component 20M is a portion connected to the bus bar 42 (see FIG. 8). The second portion 22 protrudes in the horizontal direction (for example, the X direction) from end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20M is attached to the fastening member 43 (for example, a screw or a bolt; and see FIG. 8) protruding from the bus bar 42 in the +Z direction from the Z direction, and is physically and electrically connected to the bus bar 42. In the present embodiment, the second portion 22 of the connection component 20M has a second attachment hole 22h through which the fastening member 43 passes. The second attachment hole 22h is open in the Z direction. In the second portion 22, the fastening member 43 passes through the second attachment hole 22h. An engagement member 44 (for example, a nut; and see FIG. 3) is engaged with the tip of the fastening member 43 that has passed through the second attachment hole 22h, and thus the second portion 22 is fixed to the bus bar 42. In the present embodiment, the first portion 21 and the second portion 22 form one L-shaped connection component 20M.

### 3.1.3 Second-type Electronic Component

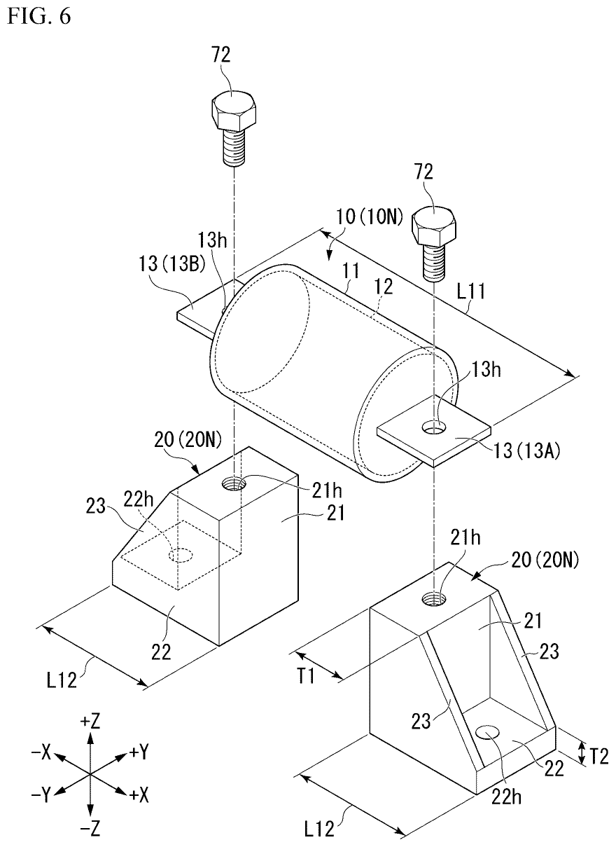

FIG. 6 is a perspective view illustrating the second-type electronic component 10N and the second-type connection component 20N. In FIG. 6, for convenience of description, the electronic component 10N and the connection component 20N are illustrated with reference to the posture of the electronic component 10 (electronic component 10U) disposed on the +Z direction side with respect to the routing board 40. The second-type electronic component 10N is an electronic component in which two terminals 13 are separately disposed at both ends in the horizontal direction of the electronic component 10N. The electronic component 10N includes, for example, a case 11, a component body 12, and a plurality of terminals 13. Note that, among the constitutions of the electronic component 10N, constitutions having functions similar to those of the electronic component 10M are denoted by the same reference numbers. In this case, in the description regarding the electronic component 10N, the “electronic component 10M” may be replaced with the “electronic component 10N” in the description regarding the electronic component 10M described above.

In the electronic component 10N, the terminal 13A and the terminal 13B are disposed separately at both ends of the electronic component 10N in the horizontal direction (for example, the X direction). Each terminal 13 has an attachment hole 13h to which a fastening member 72 (for example, a screw or a bolt) that will be described later is attached. The attachment hole 13h is open in the Z direction. For example, the attachment hole 13h of the electronic component 10N is an insertion hole through which the fastening member 72 passes. One of the terminal 13A and the terminal 13B is an example of a “first terminal”. The other of the terminal 13A and the terminal 13B is an example of a “second terminal”.

### 3.1.4 Second-type Connection Component

The second-type connection component 20N is a component that electrically connects the second-type electronic component 10N to the routing board 40. In the present embodiment, the connection component 20N electrically connects the electronic component 10N to the bus bar 42 (see FIG. 8) included in the routing board 40. In the present embodiment, a width L12 of the connection component 20N in the longitudinal direction (for example, the X direction) of the electronic component 10N is smaller than a width L11 of the electronic component 10N in the longitudinal direction. The connection component 20N includes, for example, a first portion 21, a second portion 22, and a third portion 23.

### (First Portion)

The first portion 21 of the connection component 20N is a portion connected to the terminal 13 of the electronic component 10N. The first portion 21 is a rectangular parallelepiped portion extending in the Z direction. The first portion 21 is a standing portion that stands in the Z direction with respect to the routing board 40 (for example, with respect to the bus bar 42). The first portion 21 is adjacent to the terminal 13 of the electronic component 10N in the Z direction, and is connected to the terminal 13 of the electronic component 10N from the Z direction. The first portion 21 of the connection component 20N has a first attachment hole 21h with which the fastening member 72 is engaged. The first attachment hole 21h is open in the Z direction. An inner circumferential surface of the first attachment hole 21h of the connection component 20N has a screw groove. The fastening member 72 that has passed through the attachment hole 13h of the terminal 13 of the electronic component 10N is engaged with the attachment hole 21h of the first portion 21, and thus the first portion 21 is physically and electrically connected to the terminal 13 of the electronic component 10N.

### (Second Portion)

The second portion 22 of the connection component 20N is a portion connected to the bus bar 42 (see FIG. 8). The second portion 22 protrudes in the horizontal direction (for example, the X direction) from end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20N is attached to, from the Z direction, the fastening member 43 (for example, a screw or a bolt; and see FIG. 8) protruding from the bus bar 42 in the +Z direction, and is physically and electrically connected to the bus bar 42. In the present embodiment, the second portion 22 of the connection component 20N has a second attachment hole 22h through which the fastening member 43 passes. The second attachment hole 22h is open in the Z direction. In the second portion 22, the fastening member 43 that will be described later passes through the second attachment hole 22h. An engagement member 44 (for example, a nut; and see FIG. 3) is engaged with the tip of the fastening member 43 that has passed through the second attachment hole 22h, and thus the second portion 22 is fixed to the bus bar 42.

### (Third Portion)

The third portion 23 is a standing wall (side wall) standing in the +Z direction from both ends of the second portion 22 in the horizontal direction. The third portion 23 is a wall provided in the Z direction. The third portion 23 is connected to the first portion 21 and is also connected to the second portion 22. For example, the third portion 23 extends obliquely so as to increase in the X direction as it advances in the −Z direction. The third portion 23 may be provided in the connection component 20M described above. On the other hand, the connection component 20N need not have the third portion 23.

### 3.1.5 Structure Related to Connection Component

In the present embodiment, the connection components 20 (for example, the connection component 20M and the connection component 20N) are heat storage members (heat absorbing members) that increase the heat capacity of the energization path of the electrical connection unit 1. The connection component 20 stores (absorbs) at least a part of heat generated by the electronic component 10, for example. Alternatively/additionally, the connection component 20 may store (absorb) at least a part of heat generated by the bus bar 42 itself due to energization. The connection component 20 may be referred to as a “heat storage component” or a “heat absorbing component”.

In the present embodiment, the bus bar 42 is disposed at a position away from the terminal 13 of the electronic component 10 (for example, a position away in the Z direction). The connection component 20 is disposed between the electronic component 10 and the bus bar 42. In the present disclosure, the phrase “the connection component is disposed between the electronic component and the bus bar” is not limited to a case where a part of the connection component is located between the electronic component and the bus bar when viewed from the X direction or the Y direction. The phrase “the connection component is disposed between the electronic component and the bus bar” may correspond to a case where a part of the connection component is located between the electronic component and the bus bar when viewed from a direction inclined with respect to the X direction or the Y direction. The connection component 20 electrically connects the terminal 13 of the electronic component 10 to the bus bar 42.

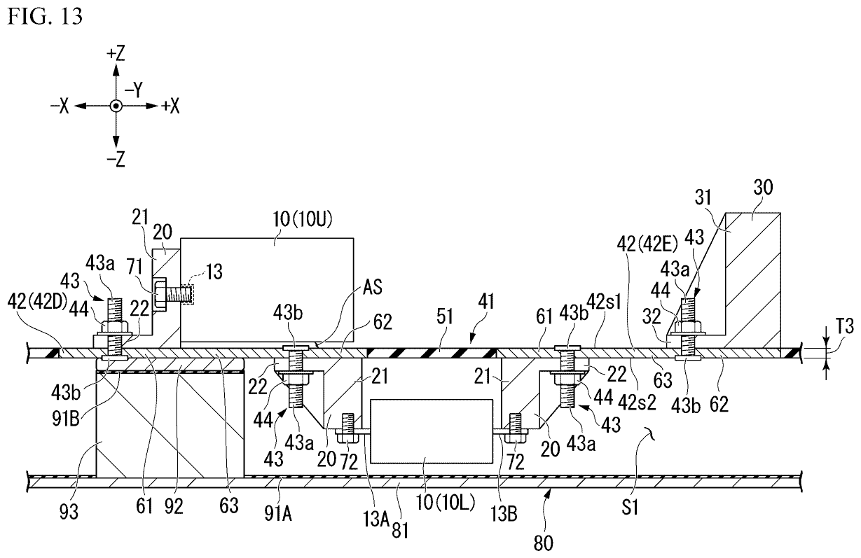

In the present embodiment, the thickness of at least a part of the connection component 20 is larger than a plate thickness (a thickness in the Z direction) T3 of the bus bar 42 (see FIG. 13). For example, a thickness T1 of at least a part of the connection component 20 in the X direction is larger than the plate thickness T3 of the bus bar 42. In the present embodiment, the thickness T1 of the first portion 21 of the connection component 20 in the X direction is larger than the plate thickness T3 of the bus bar 42. In the present embodiment, the first portion 21 has the thickness T1 larger than the plate thickness T3 of the bus bar 42 as a thickness in the X direction over the entire length of the first portion 21 in the Z direction. The thickness T1 of the first portion 21 of the connection component 20 in the X direction is, for example, twice or more the plate thickness T3 of the bus bar 42. From another point of view, a thickness T2 of the second portion 22 of the connection component 20 in the Z direction may be larger than the plate thickness T3 of the bus bar 42.

In the present embodiment, the thickness T1 of the first portion 21 of the connection component 20 in the X direction is larger than the thickness T2 of the second portion 22 of the connection component 20 in the Z direction. In the present embodiment, the first portion 21 has the thickness T1 larger than the thickness T2 of the second portion 22 in the Z direction as a thickness in the X direction over the entire length of the first portion 21 in the Z direction.

### 3.2 Connection Component for External Connection

Next, the connection component 30 for external connection will be described.

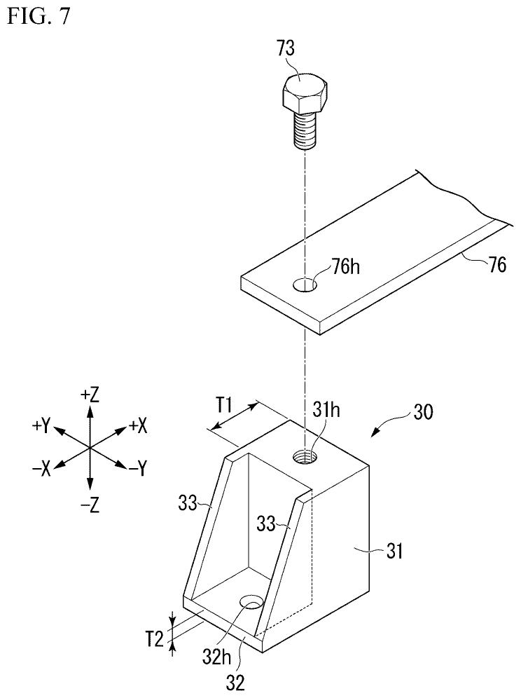

FIG. 7 is a perspective view illustrating the connection component 30 for external connection. The connection component 30 is a component that electrically connects an external connection bus bar 76 to the routing board 40. In the present embodiment, the connection component 30 electrically connects the external connection bus bar 76 to the bus bar 42 (see FIG. 8) included in the routing board 40. The external connection bus bar 76 is electrically connected to an external device. In the present disclosure, the “external device” is an electrical device existing outside the electrical connection unit 1. The external device is, for example, a battery unit mounted on a vehicle or an inverter for driving a motor of the vehicle, but is not limited to these examples. The connection component 30 includes, for example, a first portion 31, a second portion 32, and a third portion 33.

### (First Portion)

The first portion 31 is a portion connected to the external connection bus bar 76. The first portion 31 is a rectangular parallelepiped portion extending in the Z direction. The first portion 31 is a standing portion standing standing in the Z direction with respect to the routing board 40 (for example, with respect to the bus bar 42). The first portion 31 is adjacent to the external connection bus bar 76 in the Z direction, and is connected to the external connection bus bar 76 from the Z direction. The first portion 31 has a first attachment hole 31h through which a fastening member 73 (for example, a screw or a bolt) passes. The first attachment hole 31h is open in the Z direction. An inner circumferential surface of the first attachment hole 31h has a screw groove. The fastening member 73 that has passed through the attachment hole 76h of the external connection bus bar 76 is engaged with the attachment hole 31h of the first portion 31, and thus the first portion 31 is physically and electrically connected to the external connection bus bar 76.

### (Second Portion)

The second portion 32 is a portion connected to the bus bar 42 (see FIG. 8). The second portion 32 protrudes in the horizontal direction (for example, the X direction) from the end of the first portion 31 on the −Z direction side. The second portion 32 is a plate portion provided in the horizontal direction. The second portion 32 is adjacent to the bus bar 42 in the Z direction, and is connected to the bus bar 42 from the Z direction. The second portion 32 is attached to, from the Z direction, the fastening member 43 (for example, a screw or a bolt; and see FIG. 8) protruding from the bus bar 42 in the +Z direction, and is physically and electrically connected to the bus bar 42. In the present embodiment, the second portion 32 has a second attachment hole 32h through which the fastening member 43 passes. The second attachment hole 32h is open in the Z direction. In the second portion 32, the fastening member 43 that will be described later passes through the second attachment hole 32h. The engagement member 44 (for example, a nut; and see FIG. 3) is engaged with the tip of the fastening member 43 that has passed through the second attachment hole 32h, and thus the second portion 32 is fixed to the bus bar 42.

### (Third Portion)

The third portion 33 is a standing wall (side wall) standing in the +Z direction from both ends of the second portion 32 in the horizontal direction. The third portion 33 is a wall provided in the Z direction. The third portion 33 is connected to the first portion 31 and is also connected to the second portion 32. For example, the third portion 33 extends obliquely to increase in the X direction (or the Y direction) as proceeding in the −Z direction. The connection component 30 need not include the third portion 33.

Note that the dimensional relationship (for example, a dimensional relationship related to the thicknesses T1, T2, and T3) related to the connection component 20 and the bus bar 42 described above is the same for the connection component 30 to which the external connection bus bar 76 is connected. For example, in the description of the connection component 30, the “connection component 20” may be replaced with the “connection component 30” , the “first portion 21” may be replaced with the “first portion 31”, and the “second portion 22” may be replaced with the “second portion 32” in the description of the connection component 20.

### 3.3 Routing Board

Next, the routing board 40 will be described.

FIG. 8 is a perspective view illustrating the routing board 40. The routing board 40 is a member that forms at least a part of an energization path between the plurality of electronic components 10 and/or at least a part of an energization path between the electronic component 10 and an external device. In the present disclosure, the “routing board” indicates a board-type routing structure. The “board type” indicates a plate shape along one plane when viewed as a whole regardless of a fine shape. In the present disclosure, the term “plate shape”, “sheet shape”, or “planar” is not limited to the case of being completely flat, and may include a case where a fixing structure, a rib, or the like protruding in the Z direction is partially present, a case where an uneven shape following the thickness of the bus bar is present on the surface, and the like. In the present embodiment, the routing board 40 has a plate shape formed in the X direction and the Y direction.

The routing board 40 includes, for example, a base plate 41, one or more (for example, a plurality of) bus bars 42, and a plurality of fastening members 43. In the present embodiment, the base plate 41 and the plurality of bus bars 42 are integrated through insert molding. For example, the routing board 40 is formed as a single member by insert-molding the bus bar 42 with the base plate 41 after the fastening member 43 is fixed to the bus bar 42. That is, the bus bar 42 is integrated with the base plate 41 without using a fastening member such as a screw or a bolt. Note that the routing board 40 may be formed by another structure instead of the insert molding. A modification example in which the routing board 40 is formed by another structure will be described later.

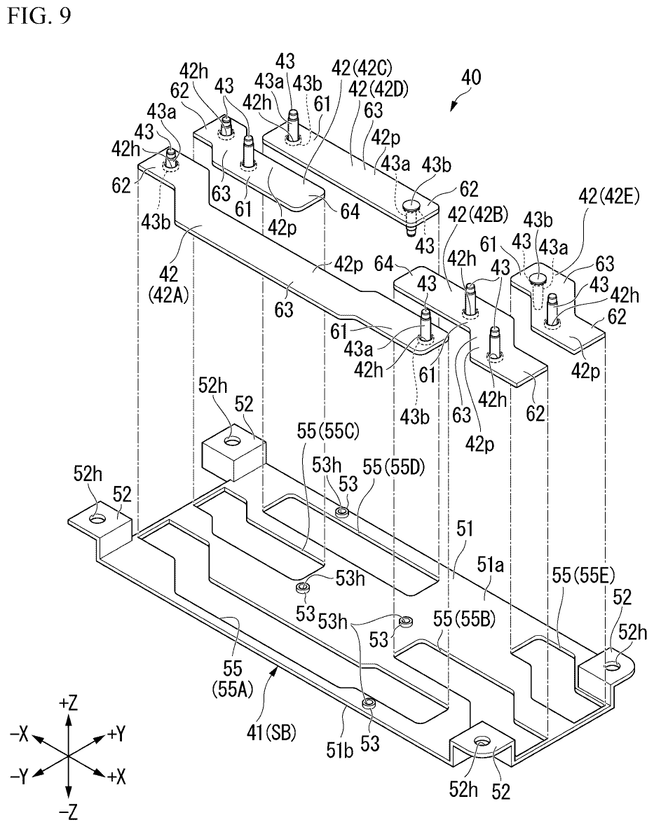

FIG. 9 is a partially exploded perspective view of the routing board 40. Hereinafter, for convenience of description, the base plate 41, the bus bar 42, and the fastening member 43 will be described with reference to the drawings in which the routing board 40 is partially exploded.

### 3.3.1 Base Plate

The base plate 41 is a holding member that integrally holds (supports) the plurality of bus bars 42 arranged at intervals in the horizontal direction. The base plate 41 is made of, for example, synthetic resin and has an insulating property. The base plate 41 electrically insulates the plurality of bus bars 42 from each other. The base plate 41 is an example of a “base member”. The base plate 41 may be referred to as an “insulating substrate”. In the present embodiment, the base plate 41 forms a support SB disposed between the plurality of electronic components 10U and 10L. In the present embodiment, the support SB is formed of one insulating member (base plate 41). The base plate 41 includes, for example, a flat surface portion 51, a plurality of fixing portions 52, and a plurality of fixing portions 53. Here, the flat surface portion 51 and the fixing portion 53 will be described. The fixing portion 52 will be described later.

### (Flat Surface Portion)

The flat surface portion 51 is a portion formed in a plate shape in the base plate 41. The flat surface portion 51 has a plate shape formed in the horizontal direction. The flat surface portion 51 forms a main portion of the base plate 41. The flat surface portion 51 forms a base portion (insulating base portion) of the base plate 41. In the present embodiment, the flat surface portion 51 extends over the entire width in the X direction of the base plate 41 and over the entire width in the Y direction of the base plate 41 except for four corner portions of the base plate 41.

The flat surface portion 51 has a first surface 51a and a second surface 51b. The first surface 51a is a surface directed in the +Z direction. The first surface 51a is a flat surface provided in the horizontal direction. The first surface 51a forms at least a part of a first surface 41s1 of the routing board 40M described above. The first surface 51a faces one or more (for example, a plurality of) electronic components 10U and faces the insulating cover 94 (see FIG. 1) of the electrical connection unit 1. The second surface 51b is located on the side opposite to the first surface 51a. The second surface 51b is a surface directed in the −Z direction. The second surface 51b is a flat surface provided in the horizontal direction. The second surface 51b forms at least a part of a second surface 41s2 of the routing board 40M described above. The second surface 51b faces one or more (for example, a plurality of) electronic components 10L and faces the metal plate 80 (see FIG. 1). A thickness direction (plate thickness direction) of the flat surface portion 51 is the Z direction.

The flat surface portion 51 has, for example, one or more (for example, a plurality of) accommodation portions 55 in which the bus bars 42 are accommodated, respectively. The plurality of accommodation portions 55 are formed apart from each other in the X direction or the Y direction. Each of the accommodation portions 55 is, for example, a through-hole penetrating the flat surface portion 51 in the Z direction (penetrating the base plate 41). Note that the accommodation portion 55 may be a recess provided on the first surface 51a or the second surface 51b of the flat surface portion 51 and recessed in the Z direction, instead of a through-hole. For example, the accommodation portion 55 may be a recess recessed from the first surface 51a of the flat surface portion 51 in the −Z direction, or may be a recess recessed from the second surface 51b of the flat surface portion 51 in the +Z direction. In the present disclosure, the phrase “the accommodation portion penetrates the flat surface portion in the first direction (Z direction)” may include a case where a part of the entire length of the accommodation portion 55 penetrates the flat surface portion 51 in the Z direction (for example, the remaining portion of the accommodation portion 55 may be a recess recessed in the Z direction, or may be provided inside the base plate 41 and not exposed to the outside of the base plate 41). Similarly, in the present disclosure, the phrase “the accommodation portion is recessed in the first direction (Z direction)” may include a case where a part of the entire length of the accommodation portion 55 is recessed in the Z direction (for example, a remaining portion of the accommodation portion 55 may be a through-hole penetrating the flat surface portion 51 in the Z direction, or may be provided inside the base plate 41 and not exposed to the outside of the base plate 41).

Each accommodation portion 55 has an outer shape corresponding to the shape of the bus bar 42 to be accommodated when viewed from the Z direction. In the present embodiment, the flat surface portion 51 includes, for example, five accommodation portions 55A, 55B, 55C, 55D, and 55E as the plurality of accommodation portions 55. The accommodation portion 55A is provided to correspond to a bus bar 42A that will be described later, and accommodates the bus bar 42A. The accommodation portion 55B is provided to correspond to a bus bar 42B that will be described later, and accommodates the bus bar 42B. The accommodation portion 55C is provided to correspond to a bus bar 42C that will be described later, and accommodates the bus bar 42C. The accommodation portion 55D is provided to correspond to a bus bar 42D that will be described later, and accommodates the bus bar 42D. The accommodation portion 55E is provided to correspond to a bus bar 42E that will be described later, and accommodates the bus bar 42E.

### (Fixing Portion)

The fixing portion 53 is a fixing portion to which the electronic component 10 is attached. The fixing portion 53 is, for example, a boss protruding in the Z direction from the flat surface portion 81. The fixing portion 83 faces the attachment portion 14 of the electronic component 10 in the Z direction. The fixing portion 53 has an engagement hole 53h that is open in the +Z direction. An inner circumferential surface of the engagement hole 53h has a screw groove. The fixing portion 53 is formed, for example, by embedding a metal component having the engagement hole 53h in the flat surface portion 51 of the base plate 41.

A fastening member 112 (for example, a screw or a bolt) passes through the attachment hole 14h of the attachment portion 14 of the electronic component 10 in the Z direction. When the fastening member 112 that has passed through the attachment hole 14h of the attachment portion 14 of the electronic component 10 is engaged with the engagement hole 53h of the fixing portion 53, the electronic component 10 is fixed to the base plate 41.

In the present embodiment, the fixing portion 53 to which the electronic component 10U is fixed protrudes in the +Z direction from the flat surface portion 51 of the base plate 41. The attachment portion 14 of the electronic component 10U is fixed to the fixing portion 53 from the +Z direction side. On the other hand, the fixing portion 53 to which the electronic component 10L is fixed protrudes in the −Z direction from the flat surface portion 51 of the base plate 41. The attachment portion 14 of the electronic component 10L is fixed to the fixing portion 53 from the −Z direction side.

### 3.3.2 Bus Bar

The bus bar 42 is a routing member (electrical connection member) included in the routing board 40. The bus bar 42 is, for example, a routing member for electrically connecting the plurality of electronic components 10. Alternatively, the bus bar 42 may be a routing member for connecting the electronic component 10 to an external device. The bus bar 42 is made of a metal (for example, copper or a copper alloy) and has conductivity. In the present embodiment, the routing board 40 includes, for example, five bus bars 42A, 42B, 42C, 42D, and 42E as the plurality of bus bars 42. The five bus bars 42A, 42B, 42C, 42D, and 42E are disposed to be arranged in the horizontal direction at intervals. The five bus bars 42A, 42B, 42C, 42D, and 42E include portions arranged on the same plane. The five bus bars 42A, 42B, 42C, 42D, and 42E are at least partially adjacent to each other in the X direction or the Y direction. The five bus bars 42A, 42B, 42C, 42D, and 42E are supported by the flat surface portion 51 of the base plate 41.

Each of the five bus bars 42A, 42B, 42C, 42D, and 42E is accommodated in the accommodation portion 55, is at least partially exposed to the first surface 51a of the base plate 41, and is at least partially exposed to the second surface 51b of the base plate 41. Each of the five accommodation portions 55A, 55B, 55C, 55D, and 55E corresponding to the five bus bars 42 may be a recess recessed from the first surface 51a of the flat surface portion 51 in the −Z direction or a recess recessed from the second surface 51b of the flat surface portion 51 in the +Z direction instead of the through-hole penetrating the base plate 41 in the Z direction.

### (Routing Structure of Bus Bar)

At least a part of each bus bar 42 has a plate shape formed in the horizontal direction. At least a part of each bus bar 42 is accommodated in the accommodation portion 55 and extends along the flat surface portion 51. That is, at least a part of each bus bar 42 extends along the first surface 51a of the flat surface portion 51. At least a part of each bus bar 42 extends in the horizontal direction in the accommodation portion 55. In the present embodiment, each bus bar 42 has a plate shape formed in the horizontal direction over the entire bus bar 42. Each of the bus bars 42 is accommodated in the accommodation portion 55 over the entire length of the bus bar 42 and extends along the flat surface portion 51. Hereinafter, a portion of each bus bar 42 that is accommodated in the accommodation portion 55 and extends along the flat surface portion 51 may be referred to as a “plate portion 42p”. The bus bar 42 is a member that forms a horizontal energization path. The bus bar 42 may be referred to as a “horizontal routing member”.

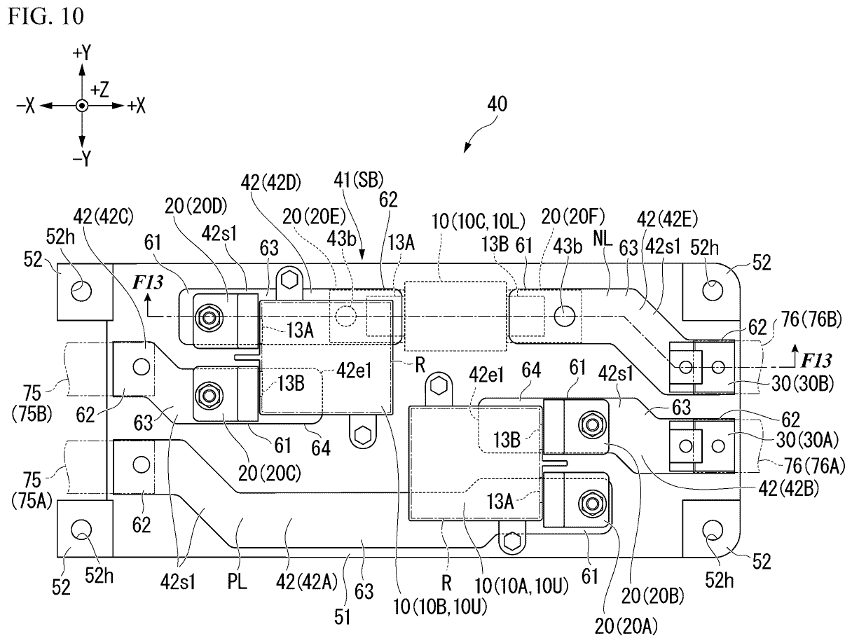

FIG. 10 is a plan view illustrating the routing board 40. The plate portion 42p of each bus bar 42 has, for example, a first connection portion 61, a second connection portion 62, and an extending portion 63.

The first connection portion 61 is a portion in contact with one connection component 20 (hereinafter referred to as a “first connection component 20”). The first connection component 20 is a connection component that connects one electronic component 10 (hereinafter referred to as a “first electronic component 10”) to the bus bar 42. The first connection portion 61 is a portion of the bus bar 42 overlapping the first connection component 20 when viewed from the Z direction. The first connection portion 61 is adjacent to the first connection component 20 in the Z direction, and is connected to the first connection component 20 from the Z direction.

The second connection portion 62 is a portion in contact with another connection component 20 (hereinafter referred to as a “second connection component 20”). The second connection component 20 is a connection component that connects another electronic component 10 (hereinafter referred to as a “second electronic component 10”) included in the plurality of electronic components 10 to the bus bar 42. The second connection portion 62 is a portion of the bus bar 42 overlapping the second connection component 20 when viewed from the Z direction. The second connection portion 62 is adjacent to the second connection component 20 in the Z direction, and is connected to the second connection component 20 from the Z direction.

Note that the second connection portion 62 may be a portion in contact with another connection component 30 (hereinafter referred to as a “second connection component 30”) instead of the above example. The connection component 30 is a connection component for connecting an external device to the bus bar 42. In this case, the second connection portion 62 is a portion of the bus bar 42 overlapping the second connection component 30 when viewed from the Z direction. The second connection portion 62 is adjacent to the second connection component 30 in the Z direction, and is connected to the second connection component 30 from the Z direction.

The second connection portion 62 may be a portion in contact with the coupling bus bar 75 for connection with another subunit SU instead of the connection components 20 and 30. In this case, the second connection portion 62 is a portion of the bus bar 42 that overlaps the coupling bus bar 75 when viewed from the Z direction. The second connection portion 62 is adjacent to the coupling bus bar 75 in the Z direction, and is connected to the coupling bus bar 75 from the Z direction.

The extending portion 63 extends from the first connection portion 61 in the X direction or the Y direction. The extending portion 63 is provided between the first connection portion 61 and the second connection portion 62. The extending portion 63 extends over the first connection portion 61 and the second connection portion 62. The extending portion 63 connects the first connection portion 61 to the second connection portion 62.

In the present embodiment, the first connection portion 61, the second connection portion 62, and the extending portion 63 have a plate shape formed in the horizontal direction. In the present embodiment, each bus bar 42 is accommodated in the accommodation portion 55 at least over the first connection portion 61 and the second connection portion 62 and extends along the flat surface portion 51. For example, the first connection portion 61, the second connection portion 62, and the extending portion 63 are accommodated in the accommodation portion 55 and extend along the flat surface portion 51.

In the present embodiment, the extending portions 63 of some of the bus bars 42 are accommodated in the accommodation portion 55 to extend over both sides of a region R through the region R overlapping the electronic component 10 when viewed from the Z direction. For example, the extending portion 63 extends linearly in the X direction. The extending portion 63 extends over a region R overlapping the electronic component 10 when viewed from the Z direction, over the +X direction side and the −X direction side of the region R. That is, the bus bar 42 is accommodated in the accommodation portion 55 to be easily routed through a better path (for example, a path with a shorter distance) without being disturbed by the presence of the electronic component 10.

The one or more bus bars 42 may have an extension 64 in addition to the first connection portion 61, the second connection portion 62, and the extending portion 63. The extension 64 is a portion where the bus bar 42 extends for the purpose of increasing a heat dissipation area and/or increasing a heat capacity for heat storage (heat absorption). The extension 64 is a portion that is not used for electrical connection. For example, the extension 64 is located on the side opposite to the extending portion 63 with respect to the first connection portion 61 (or the second connection portion 62). The extension 64 has a plate shape formed in the horizontal direction. The extension 64 is accommodated in the accommodation portion 55 and extends along the flat surface portion 51. The extension 64 extends to the region R overlapping the electronic component 10 when viewed from the Z direction, and has an end 42e1 of the bus bar 42 at a position overlapping the electronic component 10 when viewed from the Z direction.

Some routing examples of the bus bar 42 will be described below. The plurality of electronic components 10 include three electronic components 10A, 10B, and 10C. The electronic component 10A and the electronic component 10B are, for example, the first-type electronic component 10M. The electronic component 10C is, for example, the second-type electronic component 10N. The type of the electronic component 10 is not limited to the above example.

In the present embodiment, each of the electronic components 10A and 10B is an example of the electronic component 10 (electronic component 10U) disposed on the +Z direction side with respect to the base plate 41. The electronic components 10A and 10B face the first surface 51a of the flat surface portion 51 of the base plate 41 (the first surface 40s1 of the routing board 40M) from the +Z direction side. Each of electronic component 10A and electronic component 10B is an example of a “first electronic component”. From still another point of view, the electronic component 10A is an example of a “first electronic component”, and the electronic component 10B is an example of a “third electronic component”.

On the other hand, electronic component 10C is an example of the electronic component 10 (electronic component 10L) disposed on the −Z direction side with respect to base plate 41. The electronic component 10C faces the second surface 51b of the flat surface portion 51 of the base plate 41 (the second surface 40s2 of the routing board 40M) from the −Z direction side. The electronic component 10C is an example of a “second electronic component”.

In the present embodiment, the electronic component 10B (electronic component 10U) and the electronic component 10C (electronic component 10L) at least partially overlap when viewed from the Z direction. For example, when viewed from the Z direction, the electronic component 10B overlaps the terminal 13A of the electronic component 10C.

The plurality of connection components 20 include six connection components 20A, 20B, 20C, 20D, 20E, and 20F. The plurality of connection components 30 include two connection components 30A and 30B. The plurality of coupling bus bars 75 include two coupling bus bars 75A and 75B. The plurality of external connection bus bars 76 include two external connection bus bars 76A and 76B.

### (First Routing Example)

First, a routing example related to the bus bar 42A will be described. The bus bar 42A has the first connection portion 61, the second connection portion 62, and extending portion 63. The first connection portion 61 is located on the +X direction side with respect to the electronic component 10A when viewed from the Z direction. The first connection portion 61 is electrically connected to the terminal 13A of the electronic component 10A via the connection component 20A that is the first connection component 20. The second connection portion 62 is located on the −X direction side with respect to the electronic component 10A when viewed from the Z direction. The second connection portion 62 is electrically connected to another subunit SU via the coupling bus bar 75A.

The extending portion 63 is accommodated in the accommodation portion 55 to extend over both sides of the region R through the region R overlapping the electronic component 10A when viewed from the Z direction. For example, the extending portion 63 extends linearly in the X direction. The extending portion 63 extends over the region R overlapping the electronic component 10A when viewed from the Z direction, over the +X direction side and the −X direction side of the region R. The bus bar 42A is, for example, a bus bar included in the positive electrode line PL included in the electrical connection unit 1. The bus bar 42A is an example of a “first bus bar”. The accommodation portion 55A is an example of a “first accommodation portion”.

### (Second Routing Example)

Next, a routing example related to the bus bar 42B will be described. The bus bar 42B has the first connection portion 61, the second connection portion 62, the extending portion 63, and the extension 64. The first connection portion 61 is electrically connected to the terminal 13B of the electronic component 10A via the connection component 20B that is the first connection component 20. The second connection portion 62 is electrically connected to the external connection bus bar 76A via the connection component 30A that is the second connection component 30. The extension 64 extends to the region R overlapping the electronic component 10A when viewed from the Z direction, and has an end 42e1 of the bus bar 42 at a position overlapping the electronic component 10A. Similarly to the bus bar 42A, the bus bar 42B may have an extending portion 63 that extends through the region R overlapping the electronic component 10 and over both sides of the region R when viewed from the Z direction. The bus bar 42B is, for example, a bus bar included in the positive electrode line PL included in the electrical connection unit 1.

### (Third Routing Example)

Next, a routing example related to the bus bar 42C will be described. The bus bar 42C includes the first connection portion 61, the second connection portion 62, the extending portion 63, and the extension 64. The first connection portion 61 is electrically connected to the terminal 13B of the electronic component 10B via the connection component 20C that is the first connection component 20. The second connection portion 62 is electrically connected to another subunit SU via the coupling bus bar 75B. The extension 64 extends to the region R overlapping the electronic component 10B when viewed from the Z direction, and has an end 42e1 of the bus bar 42 at a position overlapping the electronic component 10B when viewed from the Z direction. The bus bar 42C is, for example, a bus bar included in the negative electrode line NL included in the electrical connection unit 1. The bus bar 42C is another example of a “first bus bar”. The accommodation portion 55C is another example of a “first accommodation portion”.

### (Fourth Routing Example)

Next, a routing example related to the bus bar 42D will be described. The bus bar 42D has the first connection portion 61, the second connection portion 62, and the extending portion 63. The first connection portion 61 is electrically connected to the terminal 13A of the electronic component 10B via the connection component 20D that is the first connection component 20. The second connection portion 62 is electrically connected to the terminal 13A of the electronic component 10C via the connection component 20E that is the second connection component 20. The bus bar 42D is, for example, a bus bar included in the negative electrode line NL included in the electrical connection unit 1. The bus bar 42D is an example of a “second bus bar”. The accommodation portion 55D is an example of a “second accommodation portion”.

### (Fifth Routing Example)

Next, a routing example related to the bus bar 42E will be described. The bus bar 42E has the first connection portion 61, the second connection portion 62, and the extending portion 63. The first connection portion 61 is electrically connected to the terminal 13B of the electronic component 10C via the connection component 20F that is the first connection component 20. The second connection portion 62 is electrically connected to the external connection bus bar 76B via the connection component 30B that is the second connection component 30. The bus bar 42E is, for example, a bus bar included in the negative electrode line NL included in the electrical connection unit 1.

### (Exposure Structure of Bus Bar)

Next, an exposure structure of the bus bar 42 will be described.

An exposure structure of the bus bar 42 will be described with reference to FIGS. 8 and 9. In the present embodiment, at least a part of the extending portion 63 of the bus bar 42 is exposed to the outside of the base plate 41 on the upper surface side and the lower surface side. For example, the extending portion 63 of the bus bar 42 is exposed to the outside of the base plate 41 on the upper surface side and the lower surface side at least in a part of a region R (see FIG. 10) overlapping the electronic component 10 when viewed from the Z direction.

In the present embodiment, the bus bar 42 is accommodated in the accommodation portion 55 at least over the entire length between the first connection portion 61 and the second connection portion 62 and extends along the first surface 51a of the flat surface portion 51. The bus bar 42 is exposed to the outside of the base plate 41 on the upper surface side and the lower surface side at least over the entire length between the first connection portion 61 and the second connection portion 62.

In the present embodiment, the bus bar 42 is accommodated in the accommodation portion 55 over the entire length of the bus bar 42 and extends along the first surface 51a of the flat surface portion 51. The bus bar 42 is exposed to the outside of the base plate 41 on the upper surface side and the lower surface side over the entire length of the bus bar 42.

### 3.3.3 Fastening Member

Next, the fastening member 43 will be described with reference to FIG. 9. The fastening member 43 is a component for fixing the bus bar 42 and a connection target component (the connection component 20, the connection component 30, or the coupling bus bar 75) of the bus bar 42. The fastening member 43 is, for example, a caulking bolt fixed to the bus bar 42. The fastening member 43 is an example of a “fastening portion”.

In the present embodiment, each of the first connection portion 61 and the second connection portion 62 of the bus bar 42 has a through-hole 42h. The through-hole 42h penetrates the bus bar 42 in the Z direction. The fastening member 43 is, for example, a bolt having a shaft 43a and a head 43b. A circumferential surface of the shaft 43a has a screw groove. The head 43b has a diameter larger than that of the shaft 43a. The head 43b of the fastening member 43 is caulked and fixed to the bus bar 42 in a state in which the shaft 43a passes through the through-hole 42h of the bus bar 42. With this fixation, the fastening member 43 is electrically and physically connected to the bus bar 42 in a state in which the shaft 43a protrudes in the Z direction from the through-hole 42h of the bus bar 42. The fastening member 43 is not limited to caulking fixation, and may be fixed to the bus bar 42 through welding or other methods.

In the present embodiment, the connection component 20 is attached to the fastening member 43 from the Z direction in a state of being previously fixed to the electronic component 10 via the fastening member 72 or the fastening member 71. For example, in the connection component 20, the shaft 43a of the fastening member 43 is inserted into the attachment hole 22h of the second portion 22. The engagement member 44 (for example, a nut) is engaged with the shaft 43a of the fastening member 43 protruding from the attachment hole 22h of the second portion 22 of the connection component 20. The engagement member 44 is attached to the shaft 43a in the Z direction, for example. This engagement fixes the second portion 22 of the connection component 20 to the fastening member 43.

In the present embodiment, the bus bar 42 has a first surface 42s1 and a second surface 42s2 (see FIG. 13). The first surface 42s1 is a surface directed in the +Z direction. On the other hand, the second surface 42s2 is located on the side opposite to the first surface 42s1. The second surface 42s2 is a surface directed in the −Z direction.

In the present embodiment, the fastening member 43 to which the connection component 20 corresponding to the electronic component 10U is attached protrudes from the first surface 42s1 of the bus bar 42 toward the +Z direction side. The connection component 20 corresponding to the electronic component 10U is attached to the bus bar 42 from the +Z direction side such that the shaft 43a of the fastening member 43 is inserted into the attachment hole 22h of the connection component 20. The connection component 20 corresponding to the electronic component 10U is fixed to the bus bar 42 via, for example, the engagement member 44 in a state of being in contact with the first surface 42s1 of the bus bar 42 from the +Z direction side.

On the other hand, the fastening member 43 to which the connection component 20 corresponding to the electronic component 10L is attached protrudes from the second surface 42s2 of the bus bar 42 toward the −Z direction side. The connection component 20 corresponding to the electronic component 10L is attached to the bus bar 42 from the −Z direction side such that the shaft 43a of the fastening member 43 is inserted into the attachment hole 22h of the connection component 20. The connection component 20 corresponding to the electronic component 10L is fixed to the bus bar 42 via, for example, the engagement member 44 in a state of being in contact with the second surface 42s2 of the bus bar 42 from the −Z direction side.

### 4. Metal Plate, Insulating Sheet, Heat Transfer Member, and Insulating Cover

Next, the metal plate 80, the insulating sheets 91A and 91B, the heat transfer member 92, the heat transfer portion 93, and the insulating cover 94 will be described.

### 4.1 Metal Plate

FIG. 11 is a partially exploded perspective view of the electrical connection unit 1. The metal plate 80 is a member for securing rigidity of the electrical connection unit 1 and enhancing a heat dissipation property of the electrical connection unit 1. The metal plate 80 is made of a metal (for example, aluminum or an aluminum alloy). The metal plate 80 is an example of a “rigid member”. The metal plate 80 may be referred to as a “metal member” or a “heat dissipation member”. In the present embodiment, the metal plate 80 is disposed on the side opposite to the routing board 40M with respect to the electronic component 10L, and the routing board 40M is fixed thereto.

The metal plate 80 has a rectangular shape formed in the X direction when viewed from the Z direction. The metal plate 80 has a first end 80e1, a second end 80e2 , a third end 80e3 , and a fourth end 80e4 (see FIG. 2). The first end 80e1 and the second end 80e2 are a pair of ends of the metal plate 80 in the longitudinal direction, and are separated in the X direction. The third end 80e3 and the fourth end 80e4 are a pair of ends of the metal plate 80 in the lateral direction, and are separated in the Y direction.

The metal plate 80 includes, for example, a flat surface portion 81 and a plurality of fixing portions 82.

The flat surface portion 81 is a portion formed in a plate shape in the metal plate 80. The flat surface portion 81 has a plate shape formed in the horizontal direction. The flat surface portion 81 forms a main portion of the metal plate 80. The flat surface portion 81 forms a base portion (metal base portion) of the metal plate 80. In the present embodiment, the flat surface portion 81 has a size that covers the three subunits SU from below. The flat surface portion 81 faces the routing boards 40 of the three subunits SU. In the present embodiment, the metal plate 80 has a space S1 (see FIG. 13) with the second surface 51b of the flat surface portion 51 of each subunit SU, and faces the second surface 51b of the flat surface portion 51 of each subunit SU. The electronic component 10L is accommodated in the space S1. That is, the electronic component 10L is disposed between the routing board 40M and the metal plate 80 in the Z direction.

The fixing portion 82 is a fixing portion for fixing the base plate 41 of each subunit SU to the metal plate 80. The fixing portion 82 is provided at a position corresponding to the fixing portion 52 of the base plate 41 of each subunit SU when viewed from the Z direction. The fixing portion 82 is a cylindrical or prismatic boss protruding in the +Z direction from the flat surface portion 81 of the metal plate 80. The fixing portion 82 faces the fixing portion 52 of the base plate 41 in the Z direction. The fixing portion 82 has an engagement hole 82h that is open in the +Z direction. An inner circumferential surface of the engagement hole 82h has a screw groove.

The base plate 41 has the fixing portion 52 fixed to the fixing portion 82 of the metal plate 80. The fixing portion 52 has an insertion hole 52h facing the engagement hole 82h of the fixing portion 82 of the metal plate 80. A fastening member 111 (for example, a screw or a bolt) passes through the insertion hole 52h. When the fastening member 111 that has passed through the insertion hole 52h of the fixing portion 52 of the base plate 41 is engaged with the engagement hole 82h of the fixing portion 82 of the metal plate 80, the base plate 41 is fixed to the metal plate 80.

### 4.2 Insulating Sheet

The insulating sheets 91A and 91B are insulating members for electrically insulating the metal plate 80 from the routing board 40M. The insulating sheets 91A and 91B are made of, for example, a synthetic resin such as polyester or polyimide, and have an insulating property.

The insulating sheet 91A has a rectangular shape along the flat surface portion 81 of the metal plate 80. The insulating sheet 91A has a sheet shape formed in the horizontal direction. The insulating sheet 91A is disposed between the flat surface portion 81 of the metal plate 80 and the routing board 40 of each subunit SU. In the present embodiment, the insulating sheet 91A has an opening through which the heat transfer portion 93 that will be described later passes. When a necessary insulating property is secured by another means, the insulating sheet 91A may be omitted.

The insulating sheet 91B has a rectangular shape along the upper surface of the heat transfer portion 93. The insulating sheet 91B has a sheet shape along the horizontal direction. The insulating sheet 91B is disposed between the heat transfer portion 93 and the heat transfer member 92. Note that the insulating sheet 91B may be provided between the routing board 40 of each subunit SU and the plurality of heat transfer members 92 instead of the above example. When a necessary insulating property is secured by another means, the insulating sheet 91B may be omitted. For example, when the heat transfer member 92 has an insulating property and the necessary insulating property is secured by the heat transfer member 92, the insulating sheet 91B may be omitted.

### 4.3 Heat Transfer Member

The heat transfer member 92 is a member for transferring heat generated by the electronic component 10 at the time of energization and/or heat (Joule heat) generated by the bus bar 42 itself at the time of energization to the metal plate 80. The heat transfer member 92 is, for example, a heat transfer sheet (for example, a thermally conductive silicone sheet) having elasticity. The heat transfer member 92 is made of a material having higher thermal conductivity than that of the base plate 41, for example. However, the heat transfer member 92 is not limited to the above example, and may be a heat transfer member made of a thermally conductive gel or another material.

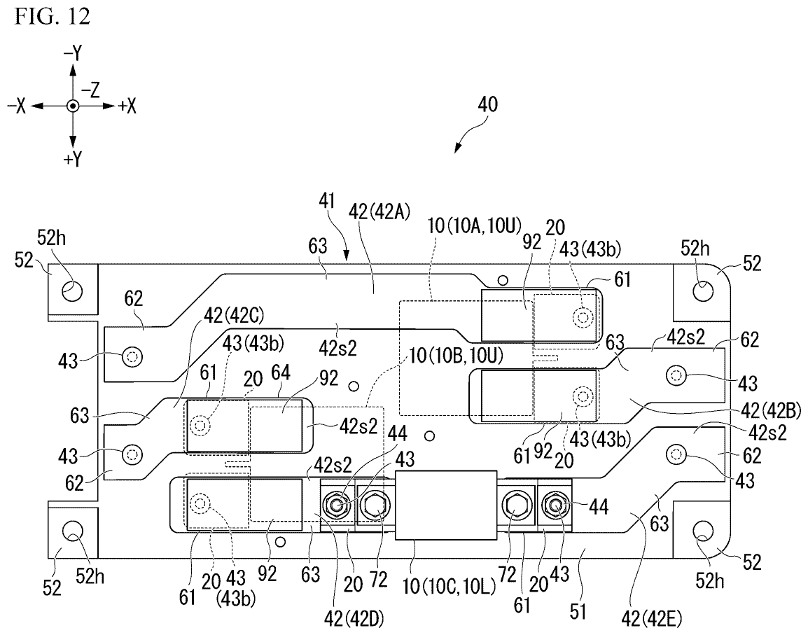

FIG. 12 is a bottom view illustrating the routing board 40. In the present embodiment, the plurality of heat transfer members 92 are partially provided in the routing board 40. For example, the plurality of heat transfer members 92 are disposed at positions overlapping a part of the bus bar 42 when viewed from the Z direction. More specifically, the plurality of heat transfer members 92 are disposed at positions overlapping a part of the bus bar 42 in the vicinity of the electronic component 10 (for example, the electronic components 10A and 10B) when viewed from the Z direction. In the present embodiment, the plurality of heat transfer members 92 are disposed at positions overlapping the connection component 20 when viewed from the Z direction. Note that the disposition position of the heat transfer member 92 is not limited to the above-described example. For example, the heat transfer member 92 may be disposed at a position not overlapping the connection component 20 or may be disposed at a position not overlapping the electronic component 10 when viewed from the Z direction.

FIG. 13 is a cross-sectional view taken along line F13-F13 of the structure illustrated in FIG. 10. In the present embodiment, the heat transfer member 92 is disposed between the metal plate 80 and the bus bar 42. The heat transfer member 92 transfers heat transferred from the electronic component 10 to the bus bar 42 and/or heat generated by the bus bar 42 from the bus bar 42 to the metal plate 80.

In the present embodiment, a part of the heat transfer member 92 is in contact with the bus bar 42 at a position overlapping the connection component 20 when viewed from the Z direction. In this case, the heat transfer member 92 easily transfers the heat transferred from the terminal 13 of the electronic component 10 to the connection component 20 from the connection component 20 to the metal plate 80 via the bus bar 42. Instead of/in addition to the above example, a part of the heat transfer member 92 may be in contact with the bus bar 42 at a position overlapping the connection component 30 when viewed from the Z direction. In this case, the heat transfer member 92 easily transfers the heat transferred from an external device to the connection component 30 from the connection component 30 to the metal plate 80 via the bus bar 42.

In the present embodiment, a part of the heat transfer member 92 is disposed at a position overlapping the head 43b of the fastening member 43 when viewed from the Z direction, and is in contact with the head 43b of the fastening member 43. In this case, the heat transfer member 92 easily transfers the heat transferred from the terminal 13 of the electronic component 10 to the connection component 20 from the fastening member 43 to the metal plate 80. When a part of the heat transfer member 92 is in contact with the head 43b of the fastening member 43, the heat transfer member 92 easily transfers the heat transferred from an external device to the connection component 30 from the fastening member 43 to the metal plate 80.

A part of the heat transfer member 92 may be in contact with the bus bar 42 at a position overlapping the electronic component 10 when viewed from the Z direction. In this case, the heat transfer member 92 easily transfers the heat transferred from the electronic component 10 to the bus bar 42 from the bus bar 42 to the metal plate 80. Note that a heat transfer member may be provided between the bus bar 42 and the electronic component 10.

In the present embodiment, the electronic component 10U is not in contact with the bus bar 42 in a region where the connection component 20 attached to the electronic component 10L and the electronic component 10U overlap each other in the Z direction. That is, in the region where the connection component 20 attached to the electronic component 10L and the electronic component 10U overlap each other in the Z direction, an air layer AS is provided between the electronic component 10U and the bus bar 42. When the air layer AS is provided between the electronic component 10U and the bus bar 42, heat transferred from the electronic component 10L to the bus bar 42 can be suppressed from being transferred from the bus bar 42 to the electronic component 10U.

This content is the same even when the correspondence relationship between the electronic component 10U and the electronic component 10L is opposite. In a region where the connection component 20 attached to the electronic component 10U and the electronic component 10L overlap each other in the Z direction, the electronic component 10L is not in contact with the bus bar 42. That is, in the region where the connection component 20 attached to the electronic component 10U and the electronic component 10L overlap each other in the Z direction, an air layer AS is provided between the electronic component 10L and the bus bar 42.

### 4.4 Heat Transfer Portion

The heat transfer portion 93 is a structure in which the space S1 between the flat surface portion 81 of the metal plate 80 and the heat transfer member 92 is filled and heat is transferred from the heat transfer member 92 to the flat surface portion 81 of the metal plate 80. The heat transfer portion 93 is an example of a protruding portion protruding from the metal plate 80 toward the routing board 40M. The heat transfer portion 93 is, for example, a block member made of metal (for example, made of copper, made of a copper alloy, made of aluminum, or made of an aluminum alloy). The heat transfer portion 93 is made of a material having a higher thermal conductivity than the heat transfer member 92. The heat transfer portion 93 is made of a rigid member that is less likely to be deformed than the heat transfer member 92. The heat transfer portion 93 is disposed at a position overlapping the heat transfer member 92 when viewed from the Z direction. For example, the heat transfer portion 93 has the same area as the heat transfer member 92 when viewed from the Z direction. The thickness of the heat transfer portion 93 in the Z direction is larger than the thickness of the heat transfer member 92 in the Z direction.

The heat transfer portion 93 is fixed to the flat surface portion 81 of the metal plate 80 and protrudes from the flat surface portion 81 of the metal plate 80 toward the heat transfer member 92. In the present embodiment, the heat transfer member 92 is compressed and held between the bus bar 42 and the heat transfer portion 93. The heat transfer portion 93 is fixed to the metal plate 80 by using, for example, a fastening member (a screw or a bolt). However, a method of fixing the heat transfer portion 93 to the metal plate 80 is not limited to the above example and may be realized by means such as an adhesive or welding.

### 4.5 Insulating Cover

Referring to FIG. 1 again, the insulating cover 94 will be described. The insulating cover 94 is a member for preventing the main body MU from contacting the energization path. The insulating cover 94 is made of, for example, a synthetic resin and has an insulating property. The insulating cover 94 has, for example, a box shape that is open on the −Z direction side. The insulating cover 94 has a plurality of vent holes 94h. The insulating cover 94 is attached to the metal plate 80 in the Z direction. Note that the insulating cover 94 is not limited to a box-shaped member, and may be a sheet-shaped member that covers the energization path of the main body MU.

### 5. Advantages

As a first comparative example, an electrical connection unit in which electronic components are disposed only on the +Z direction side of the routing board 40 will be considered. In the constitution of the first comparative example, since it is necessary to dispose a plurality of electronic components only on one side of the routing board 40 while avoiding interference between the electronic components, it may be difficult to miniaturize the electrical connection unit (for example, to reduce the area when viewed from the Z direction).

As a second comparative example, a module in which electronic components are disposed only on the +Z direction side of the routing board 40 and a rigid member (for example, the metal plate 80) is provided on the −Z direction side of the routing board 40 will be considered. An electrical connection unit formed by disposing a plurality of such modules in an overlapping manner in the Z direction will be considered. In the constitution of the second comparative example, there are a plurality of rigid members disposed apart from each other in the Z direction, and it may be difficult to reduce the height of the electrical connection unit.

On the other hand, in the present embodiment, the electrical connection unit 1 includes a support (for example, the base plate 41), a first bus bar (for example, the bus bar 42C), a second bus bar (for example, the bus bar 40D), a first electronic component (for example, the electronic component 10B), and a second electronic component (for example, the electronic component 10C). The support has a first surface (for example, the first surface 51a) and a second surface (for example, the second surface 51b) located on a side opposite to the first surface. The first bus bar is supported by the support. The second bus bar is supported by the support. The first electronic component is disposed to face the first surface of the support and is electrically connected to the first bus bar. The second electronic component is disposed to face the second surface of the support and is electrically connected to the second bus bar.

According to such a constitution, since the plurality of electronic components 10 are disposed separately on the +Z direction side and the −Z direction side of the support, the plurality of electronic components 10 hardly interfere with each other, and the plurality of electronic components 10 are easily disposed close to each other when viewed from the Z direction. Thus, for example, compared with a case where the plurality of electronic components 10 are disposed only on one side (for example, only on the +Z direction side) of the support, it is possible to miniaturize the electrical connection unit 1 (for example, to reduce the area when viewed from the Z direction).

According to another aspect, in addition to the above-described constitution, the electrical connection unit 1 includes a rigid member (for example, the metal plate 80) disposed on the −Z direction side with respect to the support and the plurality of electronic components 10. The support is fixed to the rigid member. According to such a constitution, in the constitution in which the plurality of electronic components 10 are separately disposed on the +Z direction side and the −Z direction side of the support, the strength required for the electrical connection unit 1 can be easily secured by one rigid member. Therefore, for example, the height of the electrical connection unit 1 can be reduced compared with a case where there are a plurality of rigid members disposed apart from each other in the Z direction.

In the present embodiment, the first electronic component and the second electronic component at least partially overlap when viewed from the Z direction. According to such a constitution, the plurality of electronic components 10 can be disposed closer to each other when viewed from the Z direction. Therefore, it is possible to further miniaturize the electrical connection unit 1 (for example, further reduce the area when viewed from the Z direction).

In the present embodiment, the support includes a first accommodation portion (for example, the accommodation portion 55C) recessed from the first surface or the second surface or penetrating the support in the Z direction, and a second accommodation portion (for example, 55D) recessed from the first surface or the second surface or penetrating the support in the Z direction. At least a part of the first bus bar is accommodated in the first accommodation portion. At least a part of the second bus bar is accommodated in the second accommodation portion. According to such a constitution, the height of the structure in which the support and the bus bar are integrated can be reduced compared with the case where the bus bar is placed on the surface of the support. Thus, the height of the electrical connection unit 1 can be further reduced.

In the present embodiment, the second bus bar is at least partially exposed to the first surface and at least partially exposed to the second surface. According to such a constitution, both the electronic component 10U disposed on the +Z direction side of the support and the electronic component 10L disposed on the −Z direction side of the support are easily connected to the second bus bar. This improves the degree of freedom of the routing path or component disposition of the electrical connection unit 1. Thus, the electrical connection unit 1 can be further miniaturized.

In the present embodiment, the first bus bar and the second bus bar are at least partially adjacent to each other in the X direction or the Y direction. According to such a constitution, the height of the structure in which the support and the bus bar are integrated can be reduced compared with the case where the first bus bar is disposed on the first surface of the support (on the surface on the +Z direction side) and the second bus bar is disposed on the second surface of the support (on the surface on the −Z direction side). Thus, the height of the electrical connection unit 1 can be further reduced.

In the present embodiment, the first electronic component is electrically connected to the second bus bar in addition to the first bus bar. According to such a constitution, the degree of freedom of the routing path or the component disposition of the electrical connection unit 1 is improved. Thus, the electrical connection unit 1 can be further miniaturized.

In the present embodiment, the support is formed of one or more insulating members (for example, the base plate 41). According to such a constitution, the plurality of electronic components 10 disposed separately on the +Z direction side and the −Z direction side of the support can be easily electrically connected by a simple constitution. Thus, the electrical connection unit 1 can be further miniaturized.

### 6. Modification Examples

Next, several modification examples will be described. Note that a constitution other than that described below in each modification example is the same as the constitution of the first embodiment.

### (First Modification Example)

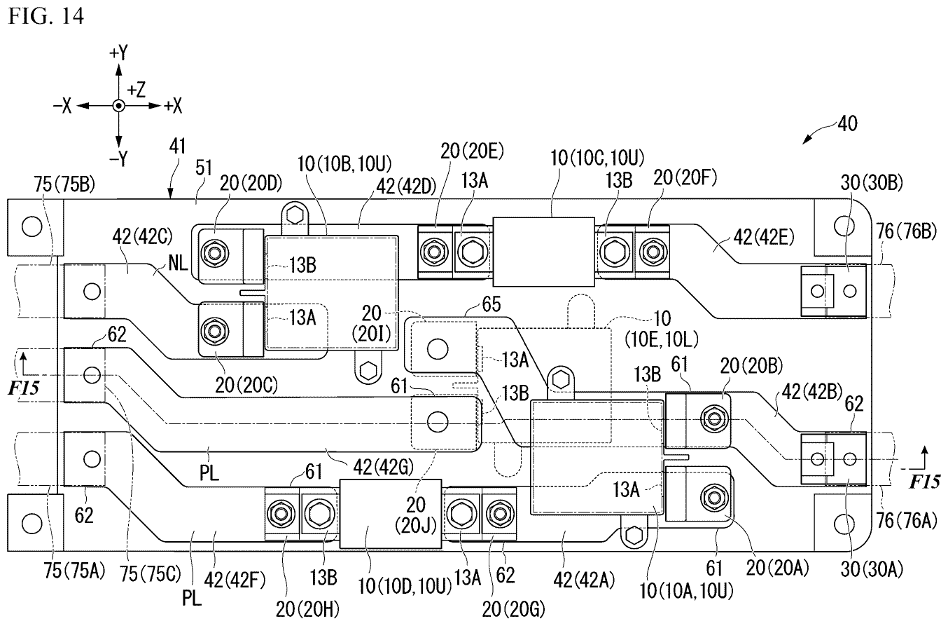

FIG. 14 is a plan view illustrating a part of an electrical connection unit 1 of a first modification example. The electrical connection unit 1 of the present modification example includes, as the electronic components 10 (electronic components 10U) disposed on the +Z direction side with respect to the base plate 41, an electronic component 10A, an electronic component 10B, an electronic component 10C, and an electronic component 10D. The electrical connection unit 1 includes an electronic component 10E as an electronic component 10 (electronic component 10L) disposed on the −Z direction side with respect to the base plate 41. The electronic component 10A is an example of a “first component”. The electronic component 10E is an example of a “second component”. In the present embodiment, the electronic component 10A and the electronic component 10E at least partially overlap when viewed from the Z direction. For example, when viewed from the Z direction, the component body 12 of the electronic component 10A and the component body 12 of the electronic component 10E at least partially overlap each other.

In the present modification example, the electrical connection unit 1 includes, as the plurality of bus bars 42, seven bus bars 42A, 42B, 42C, 42D, 42E, 42F, and 42G. The seven bus bars 42A, 42B, 42C, 42D, 42E, 42F, and 42G are at least partially adjacent to each other in the X direction or the Y direction. Each of the seven bus bars 42A, 42B, 42C, 42D, 42E, 42F, and 42G is at least partially exposed to the first surface 51a of the base plate 41 and at least partially exposed to the second surface 51b of the base plate 41.

In the present modification example, the electrical connection unit 1 includes, as the plurality of connection components 20, connection components 20A, 20B, 20C, 20D, 20E, 20F, 20H, 20I, and 20J. In addition, the electrical connection unit 1 includes coupling bus bars 75A, 75B, and 75C as the plurality of coupling bus bars 75. Here, the connection relationship between the bus bars 42B, 42C, 42D, and 42E and the electronic components 10A, 10B, and 10C is the same as that in the first embodiment. Therefore, the description of the connection relationship will be omitted.

The first connection portion 61 of the bus bar 42A is electrically connected to the terminal 13A of the electronic component 10A via the connection component 20A. The second connection portion 62 of the bus bar 42A is electrically connected to the terminal 13A of the electronic component 10D via the connection component 20G. The bus bar 42A is an example of a “first bus bar”.

The bus bar 42B includes the first connection portion 61, the second connection portion 62, and a third connection portion 65. The first connection portion 61 of the bus bar 42B is electrically connected to the terminal 13B of the electronic component 10A via the connection component 20A. The second connection portion 62 of the bus bar 42B is electrically connected to the connection component 30A. The third connection portion 65 of the bus bar 42B is electrically connected to the terminal 13A of the electronic component 10E via the connection component 20I. The bus bar 42B is an example of a “second bus bar”.

The first connection portion 61 of the bus bar 42F is electrically connected to the terminal 13B of the electronic component 10D via the connection component 20H. The second connection portion 62 of the bus bar 42F is electrically connected to the coupling bus bar 75A. The bus bar 42F is an example of a “first energization path”.

The first connection portion 61 of the bus bar 42G is electrically connected to the terminal 13B of the electronic component 10E via the connection component 20J. The second connection portion 62 of the bus bar 42G is electrically connected to the coupling bus bar 75C. The bus bar 42G is an example of a “second energization path”.

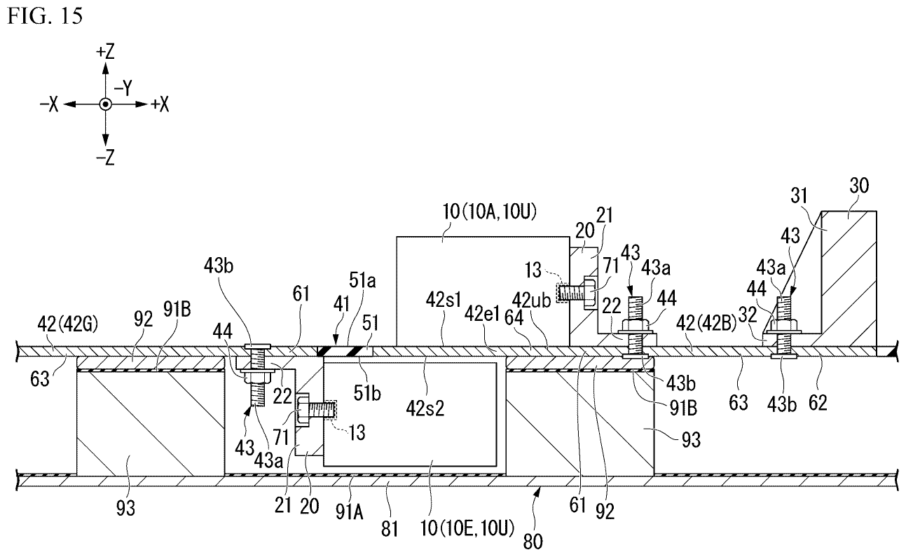

FIG. 15 is a cross-sectional view taken along line F15-F15 of the structure illustrated in FIG. 14. In the present modification example, the electronic component 10A and the connection components 20A and 20B are disposed on the +Z direction side with respect to the base plate 41. The electronic component 10E and the connection components 201 and 20J are disposed on the −Z direction side with respect to the base plate 41.

In the present modification example, the heat transfer member 92 is in contact with the extending portion 63 of the bus bar 42G to which the electronic component 10E is connected from the −Z direction side. An insulating sheet 91B and a heat transfer portion 93 are provided between the heat transfer member 92 and the flat surface portion 81 of the metal plate 80. Part of the heat transferred from the electronic component 10E to the bus bar 42G is transferred to the metal plate 80 via the heat transfer member 92 and the heat transfer portion 93.

According to such a constitution, similarly to the first embodiment, the electrical connection unit 1 can be miniaturized. In the present modification example, in the electrical connection unit in which the first energization path and the second energization path are switchable, the electronic component 10A electrically connected to the first energization path and the electronic component 10E electrically connected to the second energization path can be disposed close to each other. As a result, compared with the case where the electronic component 10A and the electronic component 10E are disposed on one side of the support, it is easy to miniaturize the electrical connection unit 1 (for example, to reduce the area when viewed from the Z direction).

### (Second Modification Example)

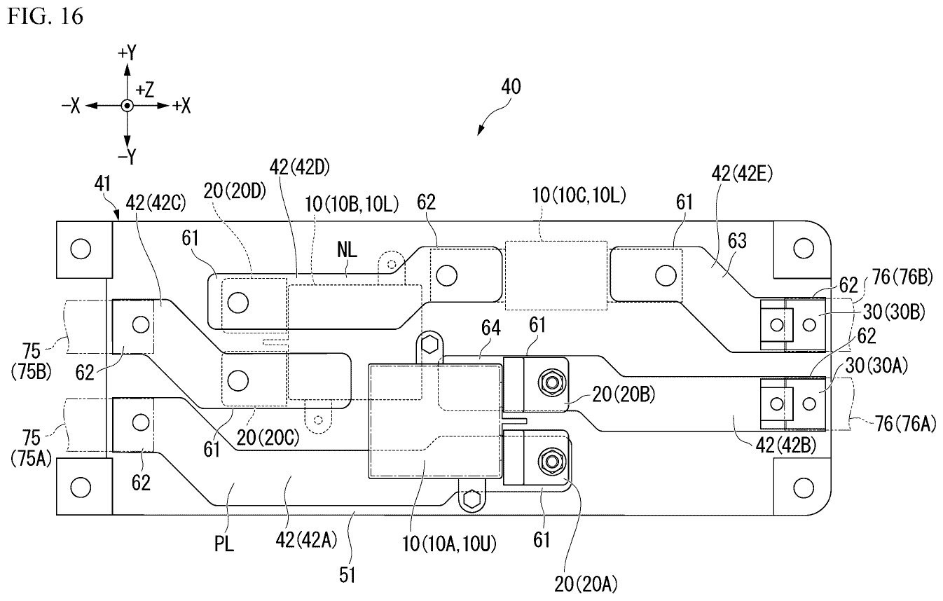

FIG. 16 is a plan view illustrating a part of an electrical connection unit 1 of a second modification example. In the present modification example, the electrical connection unit 1 includes an electronic component 10A as the electronic component 10 (a plurality of electronic components 10U) disposed on the +Z direction side with respect to the base plate 41. The electrical connection unit 1 includes electronic components 10B and 10C as the electronic components 10 (electronic components 10L) disposed on the −Z direction side with respect to the base plate 41. The electronic component 10A is an example of a “first component”. The electronic component 10B is an example of a “second component”. In the present embodiment, the electronic component 10A and the electronic component 10B at least partially overlap when viewed from the Z direction. For example, when viewed from the Z direction, the component body 12 of the electronic component 10A and the component body 12 of the electronic component 10B at least partially overlap each other.

In the present modification example, the electrical connection unit 1 includes five bus bars 42A, 42B, 42C, 42D, and 42E as the plurality of bus bars 42. The connection relationship between the five bus bars 42A, 42B, 42C, 42D, and 42E and the electronic components 10A, 10B, and 10C is the same as that in the first embodiment. Therefore, the description of the connection relationship will be omitted.

In the present modification example, the electronic component 10A and the connection components 20A and 20B are disposed on the +Z direction side with respect to the base plate 41. On the other hand, the electronic component 10B and the connection components 20C and 20D are disposed on the +Z direction side with respect to the base plate 41. The electronic component 10C and the connection components 20E and 20F are disposed on the +Z direction side with respect to the base plate 41.

According to such a constitution, similarly to the first embodiment, the electrical connection unit 1 can be miniaturized. In the present modification example, in the electrical connection unit having the positive electrode line PL and the negative electrode line NL, the electronic component 10A related to the positive electrode line PL and the electronic component 10B related to the negative electrode line NL can be disposed close to each other. As a result, compared with the case where the electronic component 10A and the electronic component 10B are disposed on one side of the support, it is easy to miniaturize the electrical connection unit 1 (for example, to reduce the area when viewed from the Z direction).

### (Third Modification Example)

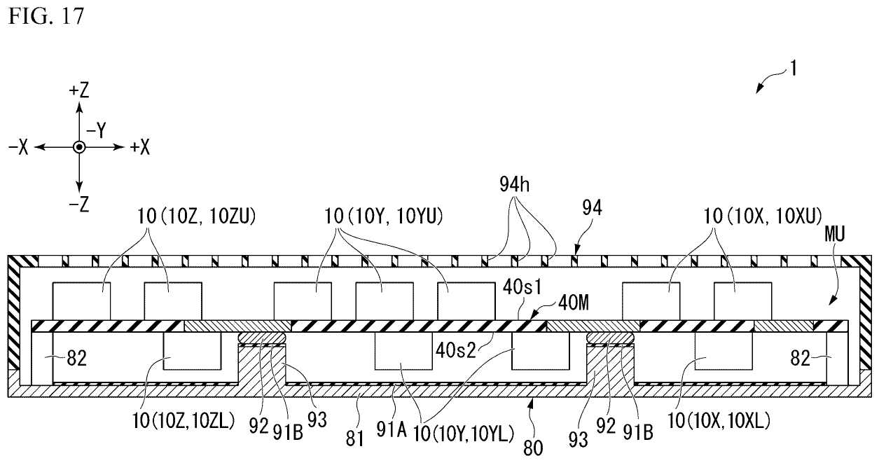

FIG. 17 is a cross-sectional view illustrating an electrical connection unit 1 of a third modification example. In the first embodiment described above, the heat transfer portion 93 and the metal plate 80 are formed as separate bodies. On the other hand, in the present modification example, the heat transfer portion 93 and the metal plate 80 are integrally provided as one piece component. That is, the heat transfer portion 93 is provided as a part of the metal plate 80 and is formed integrally with the flat surface portion 81. The heat transfer portion 93 is a protruding portion protruding in the +Z direction from a part of the flat surface portion 81. The heat transfer portion 93 has, for example, a rectangular parallelepiped shape. The shape of the heat transfer portion 93 is the same as the shape of the heat transfer portion 93 of the first embodiment.

According to such a constitution, similarly to the first embodiment, the electrical connection unit 1 can be miniaturized. In the present modification example, the heat transfer portion 93 and the metal plate 80 are provided as one piece component.

According to such a constitution, a heat transfer property between the heat transfer portion 93 and the flat surface portion 81 can be easily enhanced compared with a case where the heat transfer portion 93 and the flat surface portion 81 are separate bodies.

### (Fourth Modification Example)

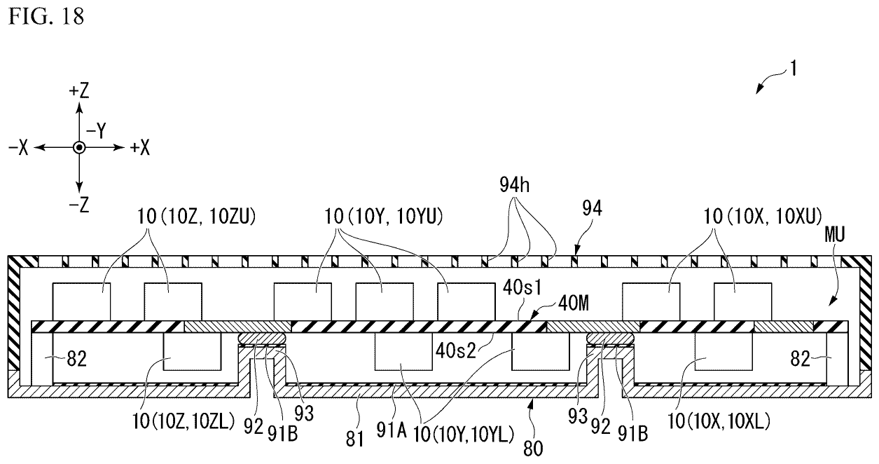

FIG. 18 is a cross-sectional view illustrating an electrical connection unit 1 of a fourth modification example. In the third modification example described above, the heat transfer portion 93 has a rectangular parallelepiped shape. On the other hand, in the present modification example, the heat transfer portion 93 is formed by deforming a part of the flat surface portion 81 toward the +Z direction side through press working or the like. Also in the present modification example, the heat transfer portion 93 is provided as a part of the metal plate 80 and is formed integrally with the flat surface portion 81. The heat transfer portion 93 is a protruding portion protruding in the +Z direction from a part of the flat surface portion 81. Even with such a constitution, the heat transfer property between the heat transfer portion 93 and the flat surface portion 81 can be easily enhanced compared with a case where the heat transfer portion 93 and the flat surface portion 81 are separate bodies.

### (Fifth Modification Example)

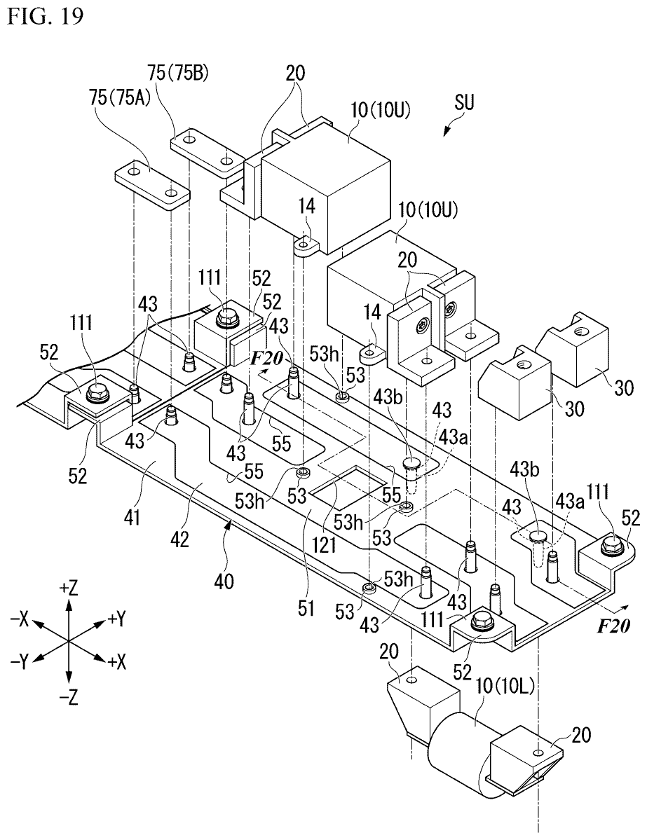

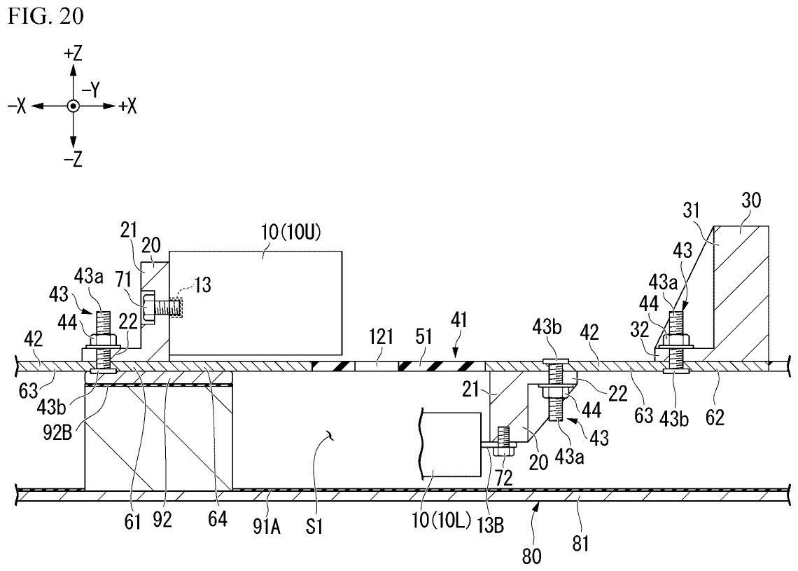

FIG. 19 is a perspective view illustrating an electrical connection unit 1 of a fifth modification example. FIG. 20 is a cross-sectional view taken along line F20-F20 of the structure illustrated in FIG. 19. As in the first embodiment, the electrical connection unit 1 of the present modification example has a space S1 in which the electronic component 10L is accommodated between the base plate 41 and the metal plate 80. When the electronic component 10L generates heat during energization, heat may be confined in the space S1.

In the present modification example, the flat surface portion 51 of the base plate 41 has a heat dissipation opening 121. The opening 121 penetrates the flat surface portion 51 in the Z direction and communicates with the space S1 between the routing board 40 and the metal plate 80. The opening 121 allows air to pass therethrough. The air in the space S1 between the routing board 40 and the metal plate 80 rises, for example, in response to being warmed, and is movable above the routing board 40 through the opening 121.

According to such a constitution, heat is less likely to be confined in the space S1 between the routing board 40 and the metal plate 80. When heat is less likely to be confined in the space S1, the heat dissipation property of the bus bar 42 is improved. When the heat dissipation property of the bus bar 42 is improved, the heat dissipation property of the electrical connection unit 1 can be further improved.

### SECOND EMBODIMENT

Next, a second embodiment will be described. The second embodiment is different from the first embodiment in that bus bars 42 are disposed in a two-layer structure in a routing board 40M. The constitution other than that described below is the same as that of the first embodiment.

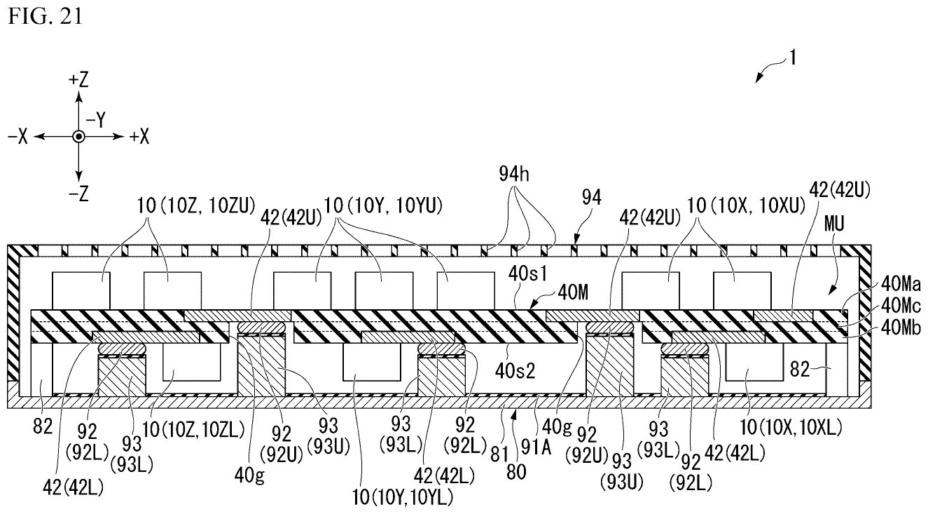

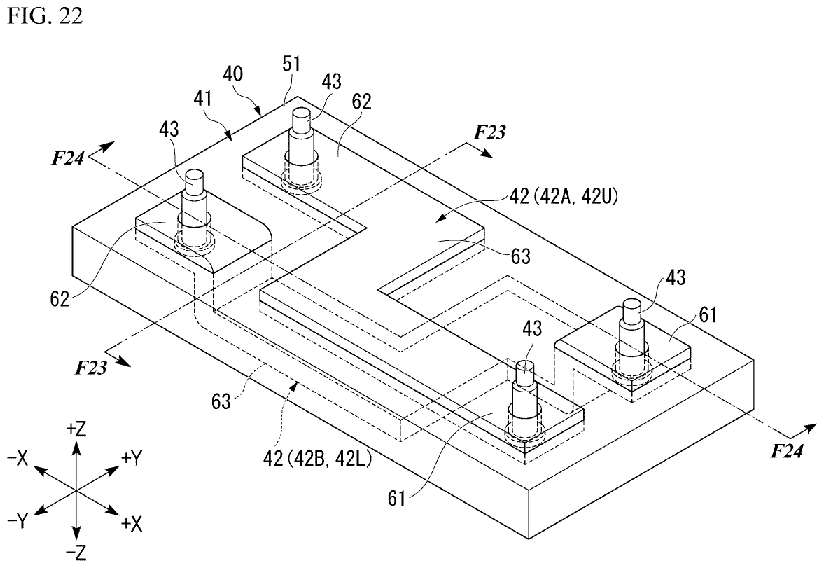

FIG. 21 is a cross-sectional view illustrating an electrical connection unit 1 of the second embodiment. In the present embodiment, the routing board 40M includes one or more base plates 41 (see FIG. 22) and a plurality of bus bars 42. The plurality of bus bars 42 include one or more bus bars 42U and one or more bus bars 42L.

The routing board 40M (the routing board 40) includes, for example, a first routing layer 40Ma, a second routing layer 40Mb, and an insulating layer 40Mc. Each of the first routing layer 40Ma, the second routing layer 40Mb, and the insulating layer 40Mc spreads in a plate shape in the horizontal direction. The first routing layer 40Ma, the second routing layer 40Mb, and the insulating layer 40Mc are layered in the Z direction.

The surface of the first routing layer 40Ma is exposed to the +Z direction side to form the first surface 40s1 of the routing board 40M. The surface of the second routing layer 40Mb is exposed to the −Z direction side to form the second surface 40s2 of the routing board 40M. The insulating layer 40Mc is disposed between the first routing layer 40Ma and the second routing layer 40Mb in the Z direction. A part of the insulating layer 40Mc is located between the bus bar 42U and the bus bar 42L in the Z direction. The insulating layer 40Mc electrically insulates the bus bar 42U from the bus bar 42L.

In the present embodiment, the first routing layer 40Ma, the second routing layer 40Mb, and the insulating layer 40Mc are integrally formed by one piece of insulating member. Alternatively, the first routing layer 40Ma, the second routing layer 40Mb, and the insulating layer 40Mc may be formed separately from each other and then layered. In addition, in a case where an insulating property between the bus bar 42U and the bus bar 42L that will be described later is secured by another means, the insulating layer 40Mc may be omitted.

The bus bar 42U is a bus bar 42 in which half or more of the bus bar 42 is disposed in the first routing layer 40Ma. At least a part of the bus bar 42U is accommodated in the accommodation portion 55 provided in the first routing layer 40Ma and extends in the horizontal direction along the first routing layer 40Ma. At least a part of the bus bar 42U is exposed to the first surface 40s1 of the routing board 40M. A part of the bus bar 42U may be bent and located in the second routing layer 40Mb. The bus bar 42U may be electrically connected to the electronic component 10U or may be electrically connected to the electronic component 10L.

The bus bar 42L is a bus bar 42 in which half or more of the bus bar 42 is disposed in the second routing layer 40Mb. At least a part of the bus bar 42L is accommodated in the accommodation portion 55 provided in the second routing layer 40Mb and extends in the horizontal direction along the second routing layer 40Mb. At least a part of the bus bar 42L is exposed to the second surface 40s2 of the routing board 40M. A part of the bus bar 42L may be bent and located in the first routing layer 40Ma. The bus bar 42L may be electrically connected to the electronic component 10U or may be electrically connected to the electronic component 10L.

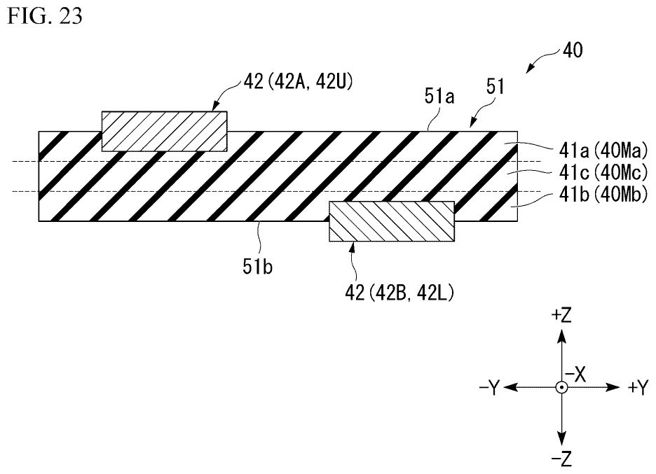

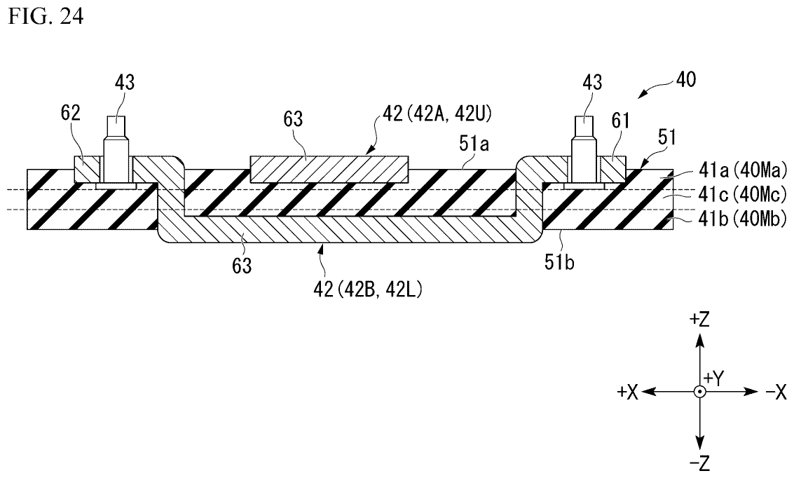

FIG. 22 is a perspective view illustrating a part of the electrical connection unit 1. FIG. 23 is a cross-sectional view taken along line F23-F23 of the structure illustrated in FIG. 22. FIG. 24 is a cross-sectional view taken along line F24-F24 of the structure illustrated in FIG. 22. The electrical connection unit 1 includes, for example, a base plate 41 and a plurality of bus bars 42(bus bars 42A and 42B).

The base plate 41 includes a first layer 41a, a second layer 41b, and a third layer 41c. The first layer 41a forms at least a part of the first routing layer 40Ma of the routing board 40M. The second layer 41b forms at least a part of the second routing layer 40Mb of the routing board 40M. The third layer 41c forms at least a part of the insulating layer 40Mc of the routing board 40M. As described above, the first layer 41a, the second layer 41b, and the third layer 41c may be integrally formed by one piece of insulating member, or may be layered after being formed separately from each other.

The bus bar 42A is an example of the above-described bus bar 42U. At least a part of the bus bar 42A is accommodated in the accommodation portion 55 provided in the first layer 41a of the base plate 41 and extends in the horizontal direction.

The bus bar 42B is an example of the above-described bus bar 42L. At least a part of the bus bar 42B is accommodated in the accommodation portion 55 provided in the second layer 41b of the base plate 41 and extends in the horizontal direction.

In the present embodiment, the bus bar 42A and the bus bar 42B at least partially overlap when viewed from the Z direction. For example, when viewed from the Z direction, the extending portion 63 of the bus bar 42A located in the first layer 41a and the extending portion 63 of the bus bar 42B located in the second layer 41b intersect and extend in a state of being separated from each other in the Z direction.

Next, referring to FIG. 21 again, a heat dissipation structure of the second embodiment will be described. In the present embodiment, the routing board 40M has an opening 40g that exposes at least a part of the bus bar 42U toward the −Z direction side. In the present embodiment, the plurality of heat transfer members 92 include one or more heat transfer members 92U in contact with the bus bar 42U and one or more heat transfer members 92L in contact with the bus bar 42L. The plurality of heat transfer portions 93 include one or more heat transfer portions 93U corresponding to the bus bar 42U and one or more heat transfer portions 93L corresponding to the bus bar 42L.

The heat transfer member 92U is inserted into the opening 40g provided in the routing board 40M, and is in contact with the bus bar 42U from the −Z direction side inside the routing board 40M. The heat transfer member 92U is in contact with the bus bar 42U in a state of being disposed inside the opening 40g. The heat transfer portion 93U protrudes more greatly on the +Z direction side than the heat transfer portion 93L. The heat transfer member 92U is compressed and held between the bus bar 42U and the heat transfer portion 93U. On the other hand, the heat transfer member 92L is in contact with the bus bar 42L from the −Z direction side outside the routing board 40M. The heat transfer member 92L is compressed and held between the bus bar 42L and the heat transfer portion 93L.

According to such a constitution, compared with the constitution of the first embodiment, it is easy to form a structure in which the plurality of bus bars 42 intersect three-dimensionally. As a result, in the structure in which the plurality of electronic components 10 are disposed separately on the +Z direction side and the −Z direction side of the support, the degree of freedom of the routing layout of the bus bar 42 can be increased. As a result, it is possible to further miniaturize the electrical connection unit 1 (for example, to reduce the area when viewed from the Z direction).

### THIRD EMBODIMENT

Next, a third embodiment will be described. The third embodiment is different from the first embodiment in that a plurality of routing boards 40M are separately disposed on the +Z direction side and the −Z direction side of the metal plate 80. The constitution other than that described below is the same as that of the first embodiment.

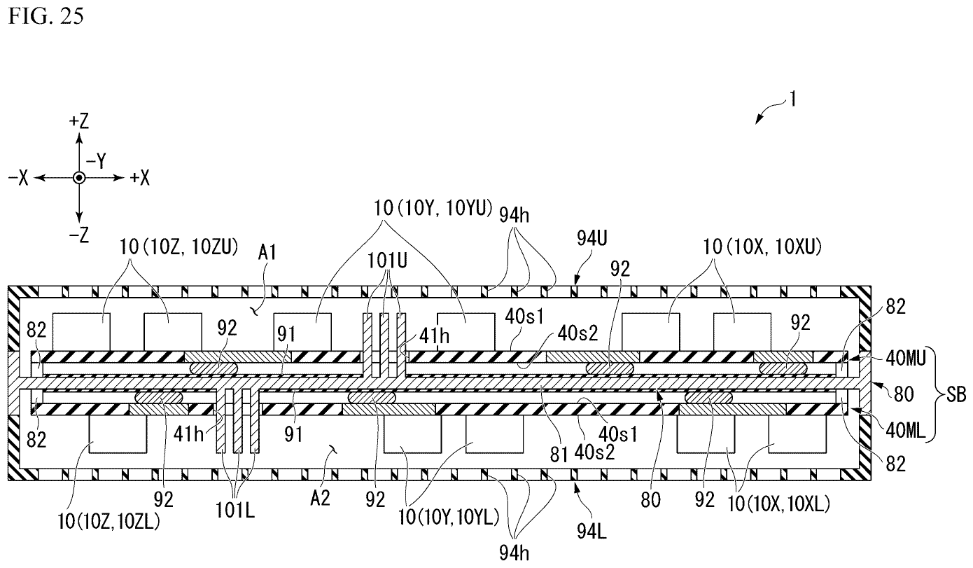

FIG. 25 is a cross-sectional view illustrating an electrical connection unit 1 of the third embodiment. In the present embodiment, the support SB includes a plurality of routing boards 40M (routing board 40MU and 40ML) and a metal plate 80.

The routing board 40MU is disposed on the +Z direction side with respect to the metal plate 80. The first surface 40s1 directed in the +Z direction in the routing board 40MU is an example of a “first surface of the support”. The base plate 41 included in the routing board 40MU is an example of a “first insulating member”. The first surface 51a of the base plate 41 forms at least a part of the first surface 40s1 directed in the +Z direction in the routing board 40MU.

The plurality of electronic components 10U are disposed on the +Z direction side with respect to the routing board 40MU. The plurality of electronic components 10U face the first surface 40s1 of the routing board 40MU. The plurality of electronic components 10U are electrically connected to one or more bus bars 42 included in the routing board 40MU. The bus bar 42 included in the routing board 40MU is an example of a “first bus bar”.

On the other hand, the electronic component 10 is not disposed between the routing board 40MU and the metal plate 80. The heat transfer member 92 is disposed between the routing board 40MU and the metal plate 80.

The routing board 40ML is disposed on the −Z direction side with respect to the metal plate 80. The second surface 40s2 directed in the −Z direction in the routing board 40ML is an example of a “second surface of the support”. The base plate 41 included in the routing board 40ML is an example of a “second insulating member”. The second surface 51b of the base plate 41 forms at least a part of the second surface 40s2 directed in the −Z direction in the routing board 40ML.

The plurality of electronic components 10L are disposed on the −Z direction side with respect to the routing board 40ML. The plurality of electronic components 10L face the second surface 40s2 of the routing board 40ML. The plurality of electronic components 10L are electrically connected to one or more bus bars 42 included in the routing board 40ML. The bus bar 42 included in the routing board 40ML is an example of a “second bus bar”.

On the other hand, the electronic component 10 is not disposed between the routing board 40ML and the metal plate 80. The heat transfer member 92 is disposed between the routing board 40ML and the metal plate 80.

In the present embodiment, the electrical connection unit 1 includes an insulating cover 94U and an insulating cover 94L as the plurality of insulating covers 94. The insulating cover 94U has, for example, a box shape that is open on the −Z direction side. The insulating cover 94U is attached to the metal plate 80 from the +Z direction side, and covers the plurality of electronic components 10U and the routing board 40MU. The insulating cover 94L has, for example, a box shape that is open on the +Z direction side. The insulating cover 94L is attached to the metal plate 80 from the −Z direction side, and covers the plurality of electronic components 10L and the routing board 40ML.

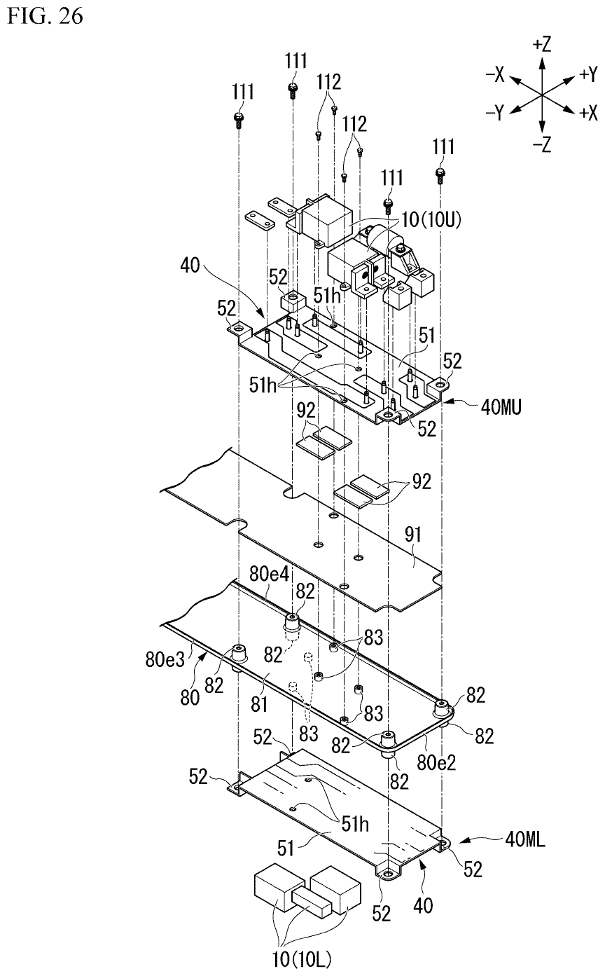

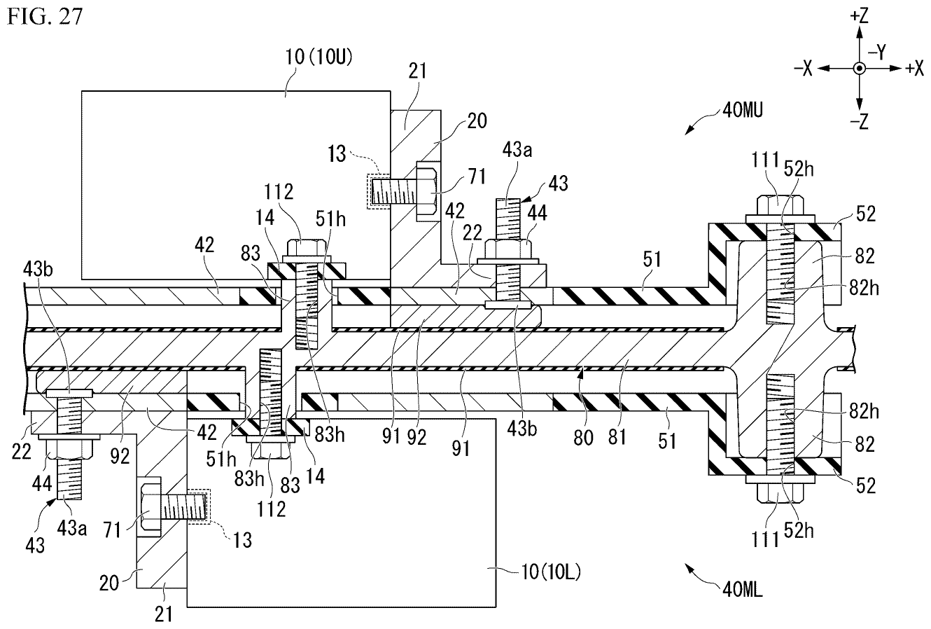

FIG. 26 is a perspective view illustrating a part of the electrical connection unit 1 of the third embodiment. FIG. 27 is a cross-sectional view illustrating a part of the electrical connection unit 1 of the third embodiment. In the present embodiment, the metal plate 80 includes a flat surface portion 81, a plurality of fixing portions 82, and a plurality of fixing portions 83.

The plurality of fixing portions 82 include a plurality of fixing portions 82 protruding in the +Z direction from the flat surface portion 81 and a plurality of fixing portions 82 protruding in the −Z direction from the flat surface portion 81. The fixing portion 52 of the routing board 40MU is fixed to the plurality of fixing portions 82 protruding in the +Z direction from the flat surface portion 81. The fixing portion 52 of the routing board 40ML is fixed to the plurality of fixing portions 82 protruding in the −Z direction from the flat surface portion 81.

The fixing portion 83 is a fixing portion for directly fixing the electronic component 10 to the metal plate 80 without the base plate 41 interposed therebetween. The fixing portion 83 is provided at a position corresponding to the attachment portion 14 of the electronic component 10 when viewed from the Z direction. The fixing portion 83 is a cylindrical or prismatic boss protruding in the Z direction from the flat surface portion 81. The plurality of fixing portions 83 include a plurality of fixing portions 83 protruding in the +Z direction from the flat surface portion 81 and a plurality of fixing portions 83 protruding in the −Z direction from the flat surface portion 81.

In the present embodiment, the flat surface portion 51 of the base plate 41 is provided with a through-hole 51h. The through-hole 51h penetrates the base plate 41 in the Z direction. The fixing portion 83 is inserted into the through-hole 51h of the flat surface portion 51 of the base plate 41. The fixing portion 83 faces the attachment portion 14 of the electronic component 10 in the Z direction. The fixing portion 83 has an engagement hole 83h that is open in the Z direction. An inner circumferential surface of the engagement hole 83h has a screw groove.

A fastening member 112 (for example, a screw or a bolt) passes through the attachment hole 14h of the attachment portion 14 of the electronic component 10 in the Z direction. When the fastening member 112 that has passed through the attachment hole 14h of the attachment portion 14 of the electronic component 10 is engaged with the engagement hole 83h of the fixing portion 83 of the metal plate 80, the electronic component 10 is fixed to the metal plate 80 without interposing the base plate 41.

Next, referring to FIG. 25 again, a heat dissipation structure according to the third embodiment will be described. In the present embodiment, the metal plate 80 includes one or more (for example, a plurality of) heat dissipation portions 101U and one or more (for example, a plurality of) heat dissipation portions 101L.

The heat dissipation portion 101U is a heat dissipation portion for promoting heat dissipation of the metal plate 80. The heat dissipation portion 101U is, for example, a protrusion or a fin made of metal. The heat dissipation portion 101U may be formed integrally with the metal plate 80 by one piece of metal member, or may be attached to the metal plate 80 after being formed separately from the metal plate 80.

In the present embodiment, the at least one heat dissipation portion 101U overlaps the heat transfer member 92 in contact with the bus bar 42 included in the routing board 40ML when viewed from the Z direction. That is, the at least one heat dissipation portion 101U overlaps the heat transfer member 92 for transferring the heat of the electronic component 10L to the metal plate 80 when viewed from the Z direction. Note that the disposition of the heat dissipation portion 101U is not limited to the above example.

The base plate 41 of the routing board 40MU has an opening 41h at a position corresponding to the heat dissipation portion 101U. The opening 41h penetrates the base plate 41 of the routing board 40MU in the Z direction. The heat dissipation portion 101U passes through the opening 41h of the base plate 41 of the routing board 40MU. The heat dissipation portion 101U protrudes from the flat surface portion 81 of the metal plate 80 to the +Z direction side beyond at least a part of the base plate 41 of the routing board 40MU. The heat dissipation portion 101U is exposed to a space A1 between the insulating cover 94U and the routing board 40MU. The heat dissipation portion 101U releases part of heat transferred from the electronic component 10U or the electronic component 10L to the metal plate 80 to the space A1 between the insulating cover 94U and the routing board 40MU.

The heat dissipation portion 101L is a heat dissipation portion for promoting heat dissipation of the metal plate 80. The heat dissipation portion 101L is, for example, a protrusion or a fin made of metal. The heat dissipation portion 101L may be formed integrally with the metal plate 80 by one piece of metal member, or may be attached to the metal plate 80 after being formed separately from the metal plate 80.

In the present embodiment, the at least one heat dissipation portion 101L overlaps the heat transfer member 92 in contact with the bus bar 42 included in the routing board 40MU when viewed from the Z direction. That is, the at least one heat dissipation portion 101L overlaps the heat transfer member 92 for transferring the heat of the electronic component 10U to the metal plate 80 when viewed from the Z direction. Note that the disposition of the heat dissipation portion 101L is not limited to the above example.

The base plate 41 of the routing board 40ML has an opening 41h at a position corresponding to the heat dissipation portion 101L. The opening 41h penetrates the base plate 41 of the routing board 40ML in the Z direction. The heat dissipation portion 101L is passed through the opening 41h of the base plate 41 of the routing board 40ML. The heat dissipation portion 101L protrudes from the flat surface portion 81 of the metal plate 80 to the −Z direction side beyond at least a part of the base plate 41 of the routing board 40ML. The heat dissipation portion 101L is exposed to a space A2 between the insulating cover 94L and the routing board 40ML. The heat dissipation portion 101U releases part of heat transferred from the electronic component 10U or the electronic component 10L to the metal plate 80 to the space A2 between the insulating cover 94L and the routing board 40ML.

According to such a constitution, similarly to the first embodiment, it is possible to miniaturize the electrical connection unit (for example, to reduce the area when viewed from the Z direction). According to the present embodiment, one metal plate 80 can be shared by the plurality of routing boards 40M. As a result, for example, the height of the electrical connection unit 1 can be reduced compared with a constitution in which a plurality of modules provided with one metal plate 80 with respect to one routing board 40M are disposed in the Z direction.

Several embodiments and modification examples have been described above. However, the embodiment and the modification examples are not limited to the examples described above. For example, some embodiments and modification examples may be implemented in combination with each other.

The routing board 40 is not limited to a structure in which the base plate 41 and the bus bar 42 are integrated through insert molding. For example, the bus bar 42 may be disposed in the accommodation portion 55 after the base plate 41 provided with the accommodation portion 55 for accommodating the bus bar 42 is molded. In this case, the bus bar 42 may be fixed to the accommodation portion 55 through fitting, or may be fixed to the accommodation portion 55 via an adhesive or other fixing means. In these cases, potting may be performed to fill a gap between the bus bar 42 and the accommodation portion 55.

A base member of the routing board 40 is not limited to the base plate 41 having the plate-shaped flat surface portion 51. The routing board 40 may be a base member (for example, an insulating sheet) having a sheet-shaped flat surface portion 51. In this case, the accommodation portion 55 may be formed by a part of the flat surface portion 51 following the outer shape of the bus bar 42. In the present disclosure, the “sheet-shaped” or “sheet” is not limited to a member having a thickness of 1 mm or more, and a member (so-called a film) having a thickness of less than 1 mm can also be used.

The base plate 41 of the routing board 40 may include a plurality of members (plate members or sheet members). The plurality of members are provided to sandwich the plurality of bus bars 42 arranged in the horizontal direction. For example, the plurality of members are integrated by sandwiching the plurality of bus bars 42 through laminate molding, for example. The plurality of members form the flat surface portion 51. In this case, the accommodation portion 55 may be formed in a hollow shape inside the base plate 41 (between the plurality of members). The plurality of members may be a plurality of plate members, a plurality of sheet members, or a combination of a plate member and a sheet member. The sheet member may be, for example, a flexible sheet member. The flat surface portion 51 formed of the plurality of members has an opening through which at least first connection portion 61 and second connection portion 62 of bus bar 42 are exposed.

A connection between the electronic component 10 and the bus bar 42 is not limited to the connection using the connection component 20. The electronic component 10 may be directly connected to the bus bar 42 by using a fastening member (for example, a bolt or a screw), welding, or the like.

### DESCRIPTION OF REFERENCE SYMBOLS

1 Electrical connection unit
SU Subunit
10 Electronic component
13, 13A, 13B Terminal
20 Connection component
30 Connection component
40 Routing board
41 Base plate
42 Bus bar
51 Flat surface portion
51a First surface
51b Second surface
55 Accommodation portion
80 Metal plate (rigid member)
101U Heat dissipation portion
101L Heat dissipation portion
SB Support

1. An electrical connection unit comprising:
a support that has a first surface and a second surface located on a side opposite to the first surface;
a first bus bar that is supported by the support;
a second bus bar that is supported by the support;
a first electronic component that faces the first surface of the support and is electrically connected to the first bus bar; and
a second electronic component that faces the second surface of the support and is electrically connected to the second bus bar.

2. The electrical connection unit according to claim 1, wherein
in a case where a direction from the first surface toward the second surface is a first direction, the first electronic component and the second electronic component at least partially overlap when viewed from the first direction.

3. The electrical connection unit according to claim 1, wherein
in a case where a direction from the first surface toward the second surface is a first direction,
the support includes a first accommodation portion recessed from the first surface or the second surface or penetrating the support in the first direction, and a second accommodation portion recessed from the first surface or the second surface or penetrating the support in the first direction,
at least a part of the first bus bar is accommodated in the first accommodation portion, and
at least a part of the second bus bar is accommodated in the second accommodation portion.

4. The electrical connection unit according to claim 1, wherein
the second bus bar is at least partially exposed to the first surface and at least partially exposed to the second surface.

5. The electrical connection unit according to claim 1, wherein
in a case where a direction from the first surface toward the second surface is a first direction and a direction intersecting the first direction is a second direction,
the first bus bar and the second bus bar are at least partially adjacent to each other in the second direction.

6. The electrical connection unit according to claim 1, wherein
the first electronic component is electrically connected to the second bus bar in addition to the first bus bar.

7. The electrical connection unit according to claim 1, further comprising
a third electronic component that faces the first surface of the support and is electrically connected to the second bus bar.

8. The electrical connection unit according to claim 1, further comprising
a rigid member that is disposed on a side opposite to the support with respect to the second electronic component and to which the support is fixed.

9. The electrical connection unit according to claim 1, wherein
the support includes
a rigid member,
a first insulating member that is located on a first side with respect to the rigid member, has the first surface, and supports the first bus bar, and
a second insulating member that is located on a second side opposite to the first side with respect to the rigid member, has the second surface, and supports the second bus bar.

10. The electrical connection unit according to claim 9, further comprising
a heat dissipation portion protruding from the rigid member toward the first side beyond at least a part of the first insulating member.
